(19) United States
(12) Patent Application Publication
(10) Pub. No.: US 2025/0369464 A1
(43) Pub. Date: Dec. 4, 2025

(54) ADVERTISEMENT SIGN CLIPS AND ASSEMBLIES

(71) Applicant: Zachary Del Green, Provo, UT (US)

(72) Inventor: Zachary Del Green, Provo, UT (US)

(21) Appl. No.: 19/220,361

(22) Filed: May 28, 2025

Related U.S. Application Data
(60) Provisional application No. 63/652,321, filed on May 28, 2024.

(51) Int. Cl. F16B 2/20; F16B 5/00; G09F 1/10

(52) U.S. Cl. CPC F16B 2/20; G09F 1/10; F16B 5/0004

(57) ABSTRACT

A sign clip includes a first side wall and a second side wall connected to the first side wall by one or more partitions. One or more slots may be defined by the first side wall, the second side wall, and the one or more partitions. One or more teeth may be disposed within the one or more slots, on an inner surface of the first side wall and on an inner surface of the second side wall. The first side wall and the second side wall are positioned to maintain a substantially constant gap therebetween. A sign clip assembly including a plurality of signs connected together by the plurality of sign clips to form a larger structure. A method of forming a sign clip assembly is also disclosed.

### CROSS-REFERENCE TO RELATED APPLICATIONS

This application claims the benefit under 35 U.S.C. § 119 (e) of U.S. Provisional Patent Application Ser. No. 63/652,321, filed May 28, 2024, the disclosure of which is hereby incorporated herein in its entirety by this reference.

### TECHNICAL FIELD

Embodiments of the present disclosure generally relate to clips. In particular, embodiments of the present disclosure relate to clips for securing multiple advertising signs relative to each other such as campaign advertising signs.

### BACKGROUND

Signs are often mass produced and used to spread information and/or messages relating to political campaigns. Signs may be displayed individually using single sign mounts, which may be planted in the ground or carried. Multiple signs may also be combined and fixed relative to each other to form larger structures. Mounting multiple signs conventionally includes securing multiple signs in a desired position with tape or another device that leaves the signs damaged after larger structure is dissembled.

### BRIEF SUMMARY

Embodiments of the disclosure include a sign clip that includes a first side wall and a second side wall connected to the first side wall by one or more partitions. One or more slots may be defined by the first side wall, the second side wall, and the one or more partitions. One or more teeth may be disposed within the one or more slots, on an inner surface of the first side wall and on an inner surface of the second side wall. The first side wall and the second side wall are positioned to maintain a substantially constant gap therebetween.

The disclosure further relates to a sign clip assembly including a plurality of sign clips that include a first side wall, a second side wall connected to the first side wall by one or more partitions, one or more slots defined by the first side wall, the second side wall, and the one or more partitions, one or more teeth disposed within the one or more slots, on an inner surface of the first side wall and on an inner surface of the second side wall. The first side wall and the second side wall are positioned to maintain a substantially constant gap therebetween. The sign clip assembly includes a plurality of signs connected together by the plurality of sign clips to form a larger structure.

A method of forming a sign clip assembly is also disclosed herein and includes providing a sign clip including a first side wall and a second side wall connected by one or more partitions to define one or more slots, and one or more teeth disposed on an inner surface of the first side wall and on an inner surface of the second side wall and extending into the one or more slots, wherein the first side wall and the second side wall are positioned to maintain a substantially constant gap therebetween. The method includes inserting a first sign into a first slot of the sign clip such that a portion of the first sign is received between the first side wall and the second side wall, and inserting a second sign into a second slot of the sign clip such that the second sign is secured relative to the first sign.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a side elevational view of a sign clip in accordance with an embodiment of the present disclosure;

FIG. 2 illustrates a bottom view of the sign clip of FIG. 1;

FIG. 3 illustrates a side elevational view of a sign clip in accordance with an embodiment of the present disclosure;

FIG. 4 illustrates a bottom view of the sign clip of FIG. 3;

FIG. 5 illustrates a side elevational view of a sign clip in accordance with an embodiment of the present disclosure;

FIG. 6 illustrates a bottom view of the sign clip of FIG. 5;

FIG. 7 illustrates a side elevational view of a sign clip in accordance with an embodiment of the present disclosure;

FIG. 8 illustrates a bottom view of the sign clip of FIG. 7;

FIG. 9 illustrates a side elevational view of a sign clip in accordance with an embodiment of the present disclosure;

FIG. 10 illustrates a bottom view of the sign clip of FIG. 9;

FIG. 11 illustrates a side elevational view of a sign clip in accordance with an embodiment of the present disclosure;

FIG. 12 illustrates a bottom view of the sign clip of FIG. 11;

FIG. 13 illustrates a side elevational view of a sign clip in accordance with an embodiment of the present disclosure;

FIG. 14 illustrates a bottom view of the sign clip of FIG. 13;

FIG. 15 illustrates a side elevational view of a sign clip in accordance with an embodiment of the present disclosure;

FIG. 16 illustrates a bottom view of the sign clip of FIG. 15;

FIG. 17 illustrates a side elevational view of a sign clip in accordance with an embodiment of the present disclosure;

FIG. 18 illustrates a bottom view of the sign clip of FIG. 17;

FIG. 19 illustrates a side elevational view of a sign clip in accordance with an embodiment of the present disclosure;

FIG. 20 illustrates a bottom view of the sign clip of FIG. 19;

FIG. 21 illustrates a side elevational view of a sign clip in accordance with an embodiment of the present disclosure;

FIG. 22 illustrates a bottom view of the sign clip of FIG. 21;

FIG. 23 illustrates a side elevational view of a sign clip in accordance with an embodiment of the present disclosure;

FIG. 24 illustrates a bottom view of the sign clip of FIG. 23;

FIG. 25 illustrates a side elevational view of a sign clip in accordance with an embodiment of the present disclosure;

FIG. 26 illustrates a bottom view of the sign clip of FIG. 25;

FIG. 27 illustrates a side elevational view of a sign clip in accordance with an embodiment of the present disclosure;

FIG. 28 illustrates a bottom view of the sign clip of FIG. 27;

FIG. 29 illustrates a side elevational view of a sign clip in accordance with an embodiment of the present disclosure;

FIG. 30 illustrates a bottom view of the sign clip of FIG. 29;

FIG. 31 illustrates a side elevational view of a sign clip in accordance with an embodiment of the present disclosure;

FIG. 32 illustrates a bottom view of the sign clip of FIG. 31;

FIG. 33 illustrates a side elevational view of a sign clip in accordance with an embodiment of the present disclosure;

FIG. 34 illustrates a bottom view of the sign clip of FIG. 33;

FIG. 35 illustrates a perspective view of a sign clip assembly in accordance with an embodiment of the present disclosure;

FIG. 36 illustrates a perspective view of a sign clip assembly in accordance with an embodiment of the present disclosure;

FIG. 37 illustrates a perspective view of a sign clip assembly in accordance with an embodiment of the present disclosure;

FIG. 38 illustrates a perspective view of a sign clip assembly in accordance with an embodiment of the present disclosure; and

FIG. 39 illustrates a perspective view of a sign clip assembly in accordance with an embodiment of the present disclosure.

### DETAILED DESCRIPTION

The illustrations presented herein are not meant to be actual views of any particular sign clip or component thereof but are merely idealized representations employed to describe illustrative embodiments. The drawings are not necessarily to scale.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “substantially” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even at least about 100% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

Political campaigns conventionally mass produce signs to allow for distribution and a show of support for issues and/or candidates coming up in an election by displaying the signs. Often, multiple signs are temporarily connected to form larger structures. The larger structures may be standalone structures and may be displayed in high traffic areas to spread awareness, information, or otherwise grab the attention of people that pass by and see the larger structures. Various shapes of sign clips are described herein that facilitate formation of the larger structures in customizable formations.

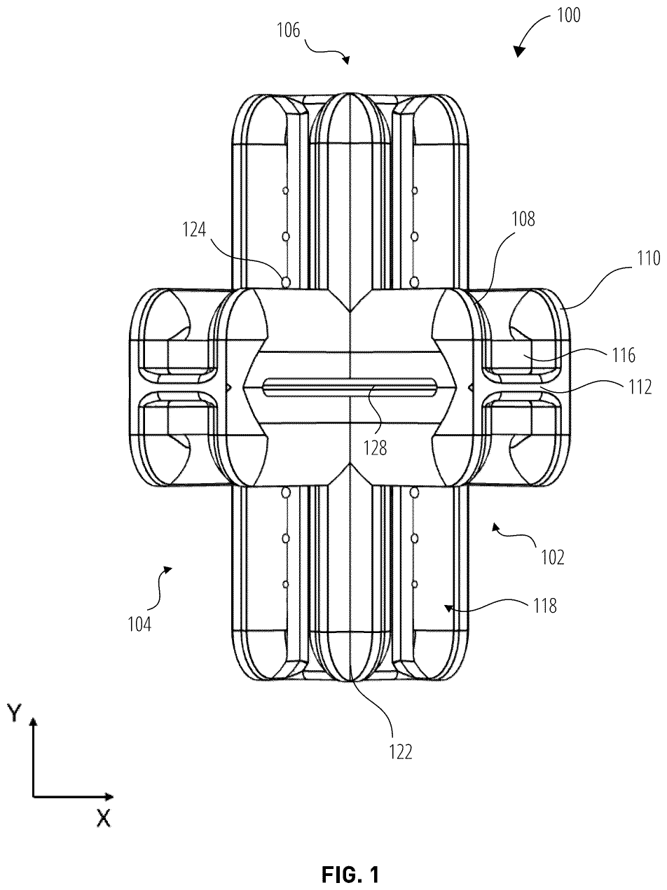

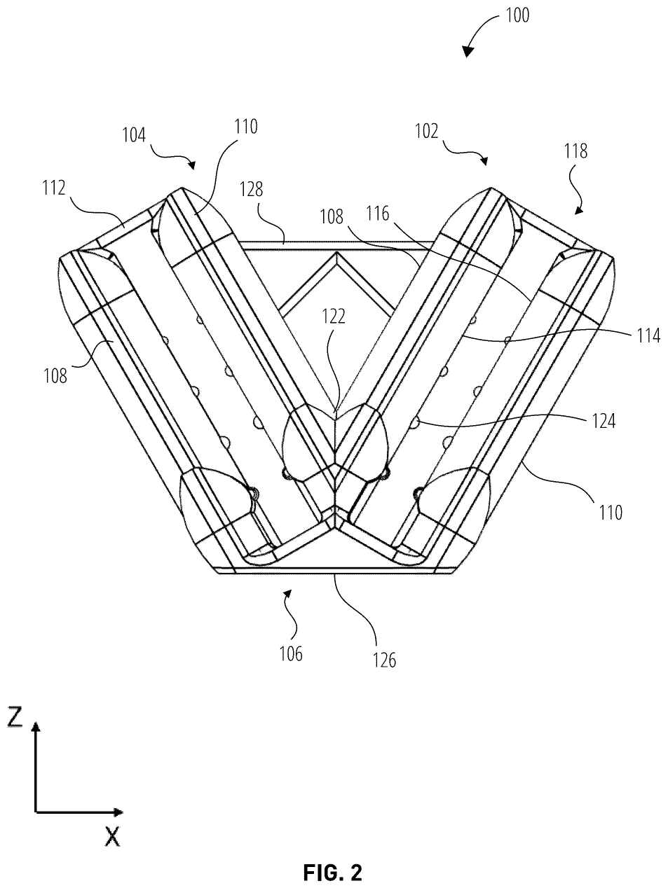

FIGS. 1 and 2 show an embodiment of a sign clip 100. The sign clip 100 may include a first portion 102 and a second portion 104 connected to the first portion 102 at a junction 106. Each of the first portion 102 and the second portion 104 includes a first side wall 108 and a second side wall 110. The first side wall 108 is connected to the second side wall 110 by one or more partitions 112. The first side wall 108 and the second side wall 110 are positioned to maintain a substantially constant gap therebetween. In some embodiments, the first side wall 108 and the second side wall 110 may not be positioned to have a substantially constant gap therebetween. The first side wall 108, the second side wall 110, and the partitions 112 may have a thickness within a range from about 0.5 mm to about 10 mm. In some embodiments, the thickness of the first side wall 108, the second side wall 110, and the partitions 112 may be within a range from about 4 mm to about 5 mm, or about 4.5 mm. The first side wall 108, the second side wall 110, and the partitions 112 may be formed of a plastic material such as a polylactic acid (PLA), polyethylene terephthalate (PET), or acrylonitrile butadiene styrene (ABS). The sign clip 100 may be formed from 3D printing, injection molding, compression molding, blow molding, or other manufacturing processes.

An interior surface 114 of the first side wall 108, an interior surface 116 of the second side wall 110, and the partitions 112 may define four slots 118 corresponding to the gap between the first side wall 108 and the second side wall 110. The slots 118 are configured to temporarily receive and fix a portion of a sign relative to the sign clip 100. Conventional signs used in advertising have a thickness of about 4.5 mm, though some signs may have thicknesses up to about 10 mm. The slots 118 may have a width, defined by the distance between the first side wall 108 and the second side wall 110, within a range of from about 2 mm to about 10 mm. In some embodiments, the width varies (e.g., tapers) along the full depth of each slot 118. For example, a shallow region of the slots 118 adjacent outer edges of the side walls 108 and 110, distal to the partition 112, may be within a range of from about 5 mm to about 9 mm. The width may then decrease through a narrow intermediate region to within a range of from about 2 mm to about 3 mm, and the width may increase toward a deepest region of the slots 118, proximal to the partition 112, to within a range of from about 4 mm to about 10 mm. In some embodiments the slots 118 may have a width of about 9 mm distal to the partition 112, a width of about 2.5 mm at the intermediate region and a width of about 4.5 mm at the deepest region proximal to the partition 112. The narrow intermediate region of the slots 118 may compress a semi-rigid corrugated sign as the sign is inserted, and the sign may elastically expand within the wider, deeper portion of the slots 118, providing frictional retention without damage to the sign.

Conventional signs used in advertising have a border around the edge of the signs with no advertisements. The slots 118 may have a depth, defined by a direction substantially perpendicular to the width of the slots 118, of about 10 mm, such as within a range of from about 5 mm to about 20 mm. The depth of the slots 118 may facilitate the slots receiving a portion of the signs corresponding to the border of the sign. The sign clip 100 may be configured to blend into the border of the sign and be less noticeable when attached to the signs, thereby facilitating the advertising on the sign to retain attention of a viewer. The length of the slots 118, defined by a direction substantially perpendicular to both the width and the depth of the slots 118, may be about 60 mm. In some embodiments, the length of the slots 118 may be within a range from about 10 mm to about 80 mm.

Referring to FIG. 1, the direction of the width, the depth, and the length of the slots 118 may vary relative to a reference plane, such as an X-Y plane or other reference plane in any X-Y, X-Z, Y-Z plane or some combination thereof. For example, the length of the slots 118 may extend substantially in the X direction for a portion of each of the slots 118 and may shift to extend substantially in the Y direction for another portion of each of the slots 118. The direction of the width, the depth, and the length of the slots 118 remain constant relative to each other even when shifting relative to the X-Y plane, or another reference plane or reference grid, which may include a third direction, Z. Varying the direction of the width, the depth, and the length of the slots 118 relative to a reference plane facilitates connection of the sign clip 100 to a corner of a sign having a substantially 90 degree angle.

Each of the interior surfaces 114 and 116 may include one or more teeth 124. For example, each of the interior surfaces 114 and 116 may include one, two, three, four, five, or more teeth 124. The teeth 124 are configured to have a height, defined by the distance from the interior surface 114 or 116, of about 3 mm. In some embodiments, the teeth 124 may have a height within a range from about 0.65 mm to about 5 mm. The distance between the teeth 124 on the interior surface 114 and the teeth 124 on the interior surface 116 may be in a range of from about 2 mm to about 4 mm. In some embodiments the distance between the teeth 124 on the interior surface 114 and the teeth 124 on the interior surface 116 may be about 2.75 mm. In some embodiments the distance between the teeth 124 on the interior surface 114 may be about 4 mm, such as within a range of from about 2 mm to about 10 mm, and the distance between the teeth 124 on the interior surface 116 may also be about 4 mm, such as within a range of from about 2 mm to about 10 mm. In some embodiments, the teeth 124 may be configured to have a hemispherical shape with a diameter of about 1.5 mm. In some embodiments the teeth 124 may have a diameter within a range of from about 0.5 mm to about 3 mm. The teeth 124 are configured to facilitate connection to the sign such that the sign will not slip out of the slots 118 unintentionally and will also not damage the sign when the sign is removed from the slots 118 intentionally. In some embodiments, teeth 124 are located at a depth of about 2.25 mm into the slots 118 from an outer edge of the first side wall 108 and second side wall 110. In some embodiments the teeth 124 may be located at the narrowest portion of the slots 118.

The junction 106 may include a corner 122 defining an angle (a) between the first side wall 108 of the first portion 102 and the second side wall 110 of the second portion 104. The angle (a) may be within a range from about 15 degrees to about 175 degrees. In some embodiments, the angle (a) is within a range from about 45 degrees to about 145 degrees or within a range from about 75 degrees to about 115 degrees. In some embodiments, the angle (a) is about 60 degrees, about 90 degrees, or about 180 degrees. The junction 106 may also include a third side wall 126 connecting the second side wall 110 of the first portion 102 and the second portion 104. In some embodiments, the corner 122 may be adjacent to or connected to the third side wall 126. The third side wall 126 may also partially define each of the slots 118.

In some embodiments the sign clip 100 may include a brace 128 disposed between the first portion 102 and the second portion 104. The brace 128 may be integral with the first side wall 108 of the first portion 102 and the first side wall 110 of the second portion 104. The brace 128 may help maintain the angular relationship of the first portion 102 to the second portion 104 during manufacture, handling, and use. In some embodiments the brace 128 may be removed after manufacture, and in some embodiments the sign clip 100 may not include a brace 128.

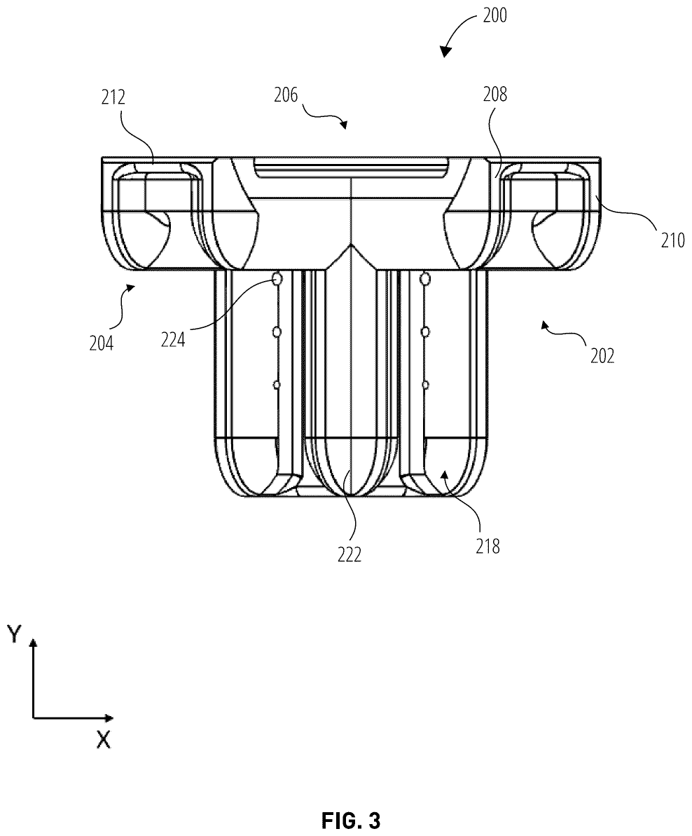

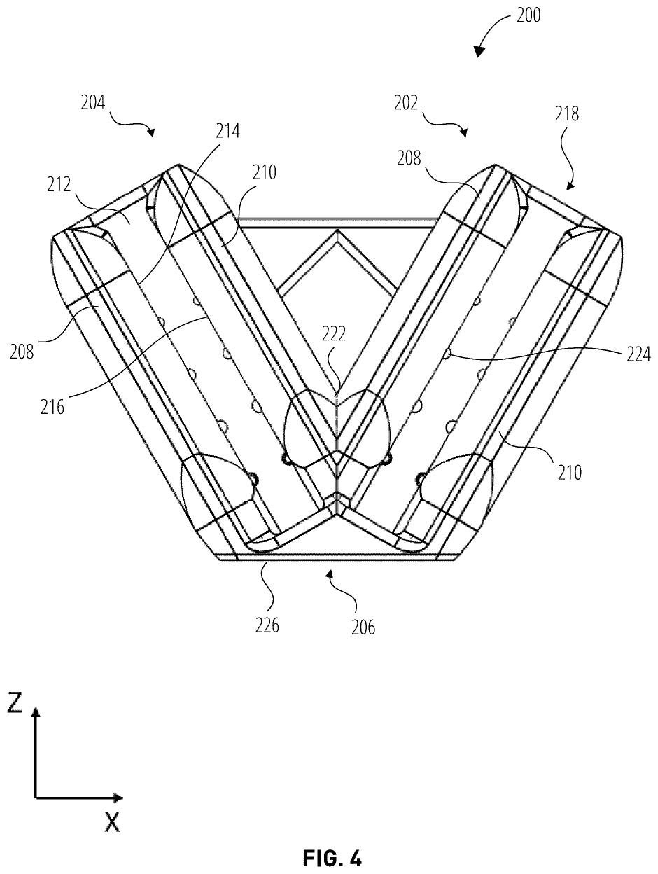

FIGS. 3 and 4 show an embodiment of a sign clip 200. The sign clip 200 may include a first portion 202 and a second portion 204 connected to the first portion 202 at a junction 206. Each of the first portion 202 and the second portion 204 includes a first side wall 208 and a second side wall 210. The first side wall 208 is connected to the second side wall 210 by one or more partitions 212. The first side wall 208 and the second side wall 210 are positioned to maintain a substantially constant gap therebetween. In some embodiments, the first side wall 208 and the second side wall 210 may not be positioned to have a substantially constant gap therebetween. The first side wall 208, the second side wall 210, and the partitions 212 may have a thickness within a range from about 0.5 mm to about 10 mm. In some embodiments, the thickness of the first side wall 208, the second side wall 210, and the partitions 212 may be within a range from about 4 mm to about 5 mm, or about 4.5 mm. The first side wall 208, the second side wall 210, and the partitions 212 may be formed of a plastic material such as a polylactic acid (PLA), polyethylene terephthalate (PET), or acrylonitrile butadiene styrene (ABS). The sign clip 200 may be formed from 3D printing, injection molding, compression molding, blow molding, or other manufacturing processes.

An interior surface 214 of the first side wall 208, an interior surface 216 of the second side wall 210, and the partitions 212 may define two slots 218 corresponding to the gap between the first side wall 208 and the second side wall 210. The slots 218 are configured to temporarily receive and fix a portion of a sign relative to the sign clip 200. Conventional signs used in advertising have a thickness of about 4.5 mm, though some signs may have thicknesses up to about 10 mm. The slots 218 may have a width, defined by the distance between the first side wall 208 and the second side wall 210, within a range of from about 2 mm to about 10 mm. In some embodiments, the width varies (e.g., tapers) along the full depth of each slot 218. For example, a shallow region of the slots 218 adjacent outer edges of the side walls 208 and 210, distal to the partition 212, may be within a range of from about 5 mm to about 9 mm. The width may then decrease through a narrow intermediate region to within a range of from about 2 mm to about 3 mm, and the width may increase toward a deepest region of the slots 218, proximal to the partition 212, to within a range of from about 4 mm to about 10 mm. In some embodiments the slots 218 may have a width of about 9 mm distal to the partition 212, a width of about 2.5 mm at the intermediate region and a width of about 4.5 mm at the deepest region proximal to the partition 212. The narrow intermediate region of the slots 218 may compress a semi-rigid corrugated sign as the sign is inserted, and the sign may then elastically expand within the wider, deeper portion of the slots 218, providing frictional retention without damage to the sign.

Conventional signs used in advertising have a border around the edge of the signs with no advertisements. The slots 218 may have a depth, defined by a direction substantially perpendicular to the width of the slots 218, of about 10 mm. The depth of the slots 218 may facilitate the slots receiving a portion of the signs corresponding to the border of the sign. The sign clip 200 may be configured to blend into the border of the sign and be less noticeable when attached to the signs, thereby facilitating the advertising on the sign to retain attention of a viewer. The length of the slots 218, defined by a direction substantially perpendicular to both the width and the depth of the slots 218, may be about 60 mm. In some embodiments, the length of the slots 218 may be within a range from about 10 mm to about 80 mm.

Referring to FIG. 3, the direction of the width, the depth, and the length of the slots 218 may vary relative to a reference plane, such as an X-Y plane or other reference plane in any X-Y, X-Z, Y-Z plane or some combination thereof. For example, the length of the slots 218 may extend substantially in the X direction for a portion of each of the slots 218 and may shift to extend substantially in the Y direction for another portion of each of the slots 218. The direction of the width, the depth, and the length of the slots 218 remain constant relative to each other even when shifting relative to the X-Y plane, or another reference plane or reference grid, which may include a third direction, Z. Varying the direction of the width, the depth, and the length of the slots 218 relative to a reference plane facilitates connection of the sign clip 200 to a corner of a sign having a substantially 90 degree angle.

Each of the interior surfaces 214 and 216 may include one or more teeth 224. For example, each of the interior surfaces 214 and 216 may include one, two, three, four, five, or more teeth 224. The teeth 224 are configured to have a height, defined by the distance from the interior surface 214 or 216, of about 3.0 mm. In some embodiments, the teeth 224 may have a height within a range from about 0.65 mm to about 5 mm. The distance between the teeth 224 on the interior surface 214 and the opposing teeth 224 on the interior surface 216 may be in a range of from about 2 mm to about 4 mm. In some embodiments the distance between the teeth 224 on the interior surface 214 and the teeth 224 on the interior surface 216 may be about 2.75 mm. In some embodiments, the teeth 224 may be configured to have a hemispherical shape with a diameter of about 1.5 mm. In some embodiments the teeth 224 may have a diameter within a range of from about 0.5 mm to about 3 mm. The teeth 224 are configured to facilitate connection to the sign such that the sign will not slip out of the slots 218 unintentionally and will also not damage the sign when the sign is removed from the slots 218 intentionally. In some embodiments, teeth 224 are located at a depth of about 2.25 mm into the slots 218 from an outer edge of the first side wall 208 and second side wall 210. In some embodiments the teeth 224 may be located at the narrowest portion of the slots 218.

The junction 206 may include a corner 222 defining an angle (a) between the first side wall 208 of the first portion 202 and the second portion 204. The angle (a) may be within a range from about 15 degrees to about 175 degrees. In some embodiments, the angle (a) is within a range from about 45 degrees to about 145 degrees or within a range from about 75 degrees to about 115 degrees. In some embodiments, the angle (a) is about 60 degrees, about 90 degrees, or about 180 degrees. The junction 206 may also include a third side wall 226 connecting the second side wall 210 of the first portion 202 and the second portion 204. In some embodiments, the corner 222 may be adjacent to or connected to the third side wall 226. The third side wall 226 may also partially define each of the slots 218.

In some embodiments the sign clip 200 may include a brace 228 disposed between the first portion 202 and the second portion 204. The brace 228 may be integral with the first side wall 208 of the first portion 202 and the first side wall 210 of the second portion 204. The brace 228 may help maintain the angular relationship of the first portion 202 to the second portion 204 during manufacture, handling, and use. In some embodiments the brace 228 may be removed after manufacture, and in some embodiments the sign clip 200 may not include a brace 228.

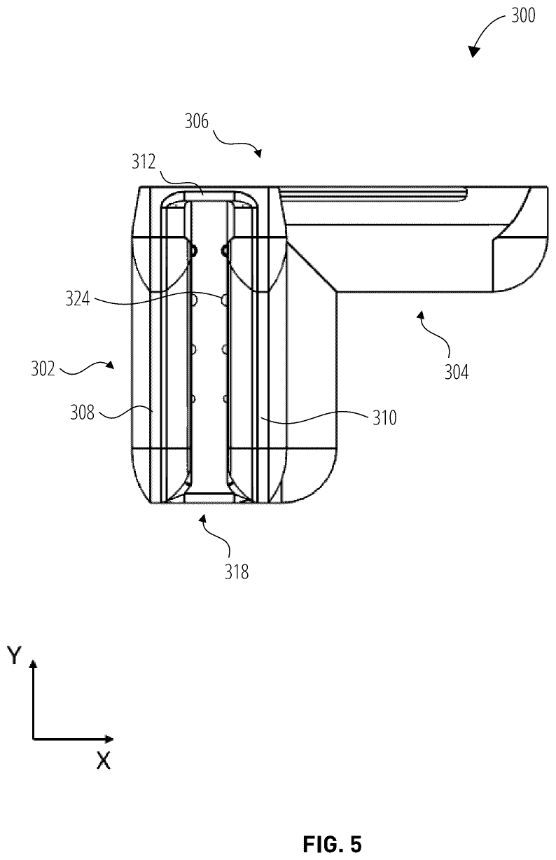

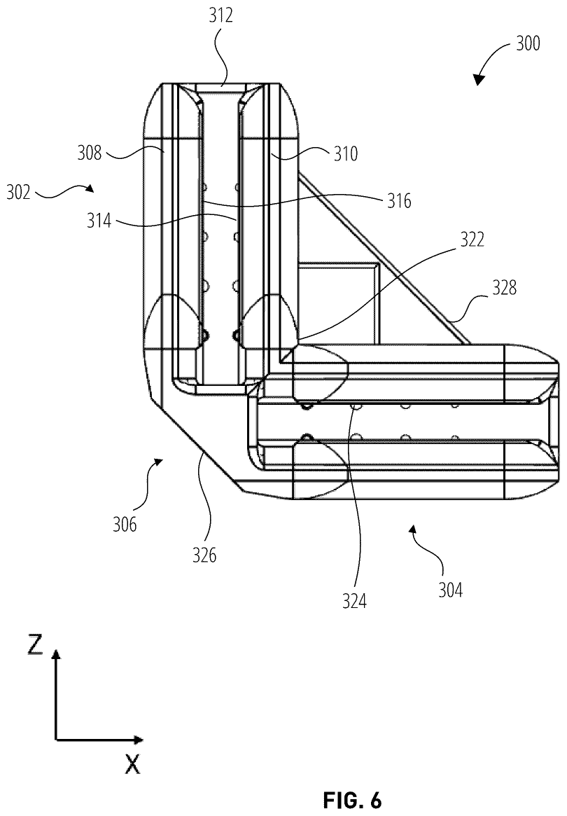

FIGS. 5 and 6 show an embodiment of a sign clip 300. The sign clip 300 may include a first portion 302 and a second portion 304 connected to the first portion 302 at a junction 306. Each of the first portion 302 and the second portion 304 includes a first side wall 308 and a second side wall 310. The first side wall 308 is connected to the second side wall 310 by one or more partitions 312. The first side wall 308 and the second side wall 310 are positioned to maintain a substantially constant gap therebetween. In some embodiments, the first side wall 308 and the second side wall 310 may not be positioned to have a substantially constant gap therebetween. The first side wall 308, the second side wall 310, and the partitions 312 may have a thickness within a range from about 0.5 mm to about 10 mm. In some embodiments, the thickness of the first side wall 308, the second side wall 310, and the partitions 312 may be within a range from about 4 mm to about 5 mm, or about 4.5 mm. The first side wall 308, the second side wall 310, and the partitions 312 may be formed of a plastic material such as a polylactic acid (PLA), polyethylene terephthalate (PET), or acrylonitrile butadiene styrene (ABS). The sign clip 300 may be formed from 3D printing, injection molding, compression molding, blow molding, or other manufacturing processes.

An interior surface 314 of the first side wall 308, an interior surface 316 of the second side wall 310, and the partitions 312 may define two slots 318 corresponding to the gap between the first side wall 308 and the second side wall 310. The slots 318 are configured to temporarily receive and fix a portion of a sign relative to the sign clip 300. Conventional signs used in advertising have a thickness of about 4.5 mm, though some signs may have thicknesses up to about 10 mm. The slots 318 may have a width, defined by the distance between the first side wall 308 and the second side wall 310, within a range of from about 2 mm to about 10 mm. In some embodiments, the width varies (e.g., tapers) along the full depth of each slot 318. For example, a shallow region of the slots 318 adjacent outer edges of the side walls 308 and 310, distal to the partition 312, may be within a range of from about 5 mm to about 9 mm. The width may then decrease through a narrow intermediate region to within a range of from about 2 mm to about 3 mm, and the width may increase toward a deepest region of the slots 318, proximal to the partition 312, to within a range of from about 4 mm to about 10 mm. In some embodiments the slots 318 may have a width of about 9 mm distal to the partition 312, a width of about 2.5 mm at the intermediate region and a width of about 4.5 mm at the deepest region proximal to the partition 312. The narrow intermediate region of the slots 318 may compress a semi-rigid corrugated sign as the sign is inserted, and the sign may then elastically expand within the wider, deeper portion of the slots 318, providing frictional retention without damage to the sign.

The slots 318 may have a depth, defined by a direction substantially perpendicular to the width of the slots 318, of about 10 mm. The depth of the slots 318 may facilitate the slots receiving a portion of the signs corresponding to the border of the sign. The sign clip 300 may be configured to blend into the border of the sign and be less noticeable when attached to the signs, thereby facilitating the advertising on the sign to retain attention of a viewer. The length of the slots 318, defined by a direction substantially perpendicular to both the width and the depth of the slots 318, may be about 60 mm. In some embodiments, the length of the slots 318 may be within a range from about 10 mm to about 80 mm.

Referring to FIG. 5, the direction of the width, the depth, and the length of the slots 318 may vary relative to a reference plane, such as an X-Y plane or other reference plane in any X-Y, X-Z, Y-Z plane or some combination thereof. For example, the length of the slots 318 may extend substantially in the X direction for a portion of each of the slots 318 and may shift to extend substantially in the Y direction for another portion of each of the slots 318. The direction of the width, the depth, and the length of the slots 318 remain constant relative to each other even when shifting relative to the X-Y plane, or another reference plane or reference grid, which may include a third direction, Z. Varying the direction of the width, the depth, and the length of the slots 318 relative to a reference plane facilitates connection of the sign clip 300 to a corner of a sign having a substantially 90 degree angle.

Each of the interior surfaces 314 and 316 may include one or more teeth 324. For example, each of the interior surfaces 314 and 316 may include one, two, three, four, five, or more teeth 324. The teeth 324 are configured to have a height, defined by the distance from the interior surface 314 or 316, of about 3.0 mm. In some embodiments, the teeth 324 may have a height within a range from about 0.65 mm to about 3.0 mm. The distance between the teeth 324 on the interior surface 314 and the teeth 324 on the interior surface 316 may be in a range of from about 2 mm to about 4 mm. In some embodiments the distance between the teeth 324 on the interior surface 314 and the teeth 324 on the interior surface 316 may be about 2.75 mm. In some embodiments, the teeth 324 may be configured to have a hemispherical shape with a diameter of about 1.5 mm. In some embodiments the teeth 324 may have a diameter within a range of from about 0.5 mm to about 3 mm. The teeth 324 are configured to facilitate connection to the sign such that the sign will not slip out of the slots 318 unintentionally and will also not damage the sign when the sign is removed from the slots 318 intentionally. In some embodiments, teeth 324 are located at a depth of about 2.25 mm into the slots 318 from an outer edge of the first side wall 308 and second side wall 310. In some embodiments the teeth 324 may be located at the narrowest portion of the slots 318.

The junction 306 may include a corner 322 defining an angle (a) between the first side wall 308 of the first portion 302 and the second portion 304. The angle (a) may be within a range from about 15 degrees to about 175 degrees. In some embodiments, the angle (a) is within a range from about 45 degrees to about 145 degrees or within a range from about 75 degrees to about 115 degrees. In some embodiments, the angle (a) is about 60 degrees, about 90 degrees, or about 180 degrees. The junction 306 may also include a third side wall 326 connecting the second side wall 310 of the first portion 302 and the second portion 304. In some embodiments, the corner 322 may be adjacent to or connected to the third side wall 326. The third side wall 326 may also partially define each of the slots 318.

In some embodiments the sign clip 300 may include a brace 328 disposed between the first portion 302 and the second portion 304. The brace 328 may be integral with the first side wall 308 of the first portion 302 and the first side wall 310 of the second portion 304. The brace 328 may help maintain the angular relationship of the first portion 302 to the second portion 304 during manufacture, handling, and use. In some embodiments the brace 328 may be removed after manufacture, and in some embodiments the sign clip 300 may not include a brace 328.

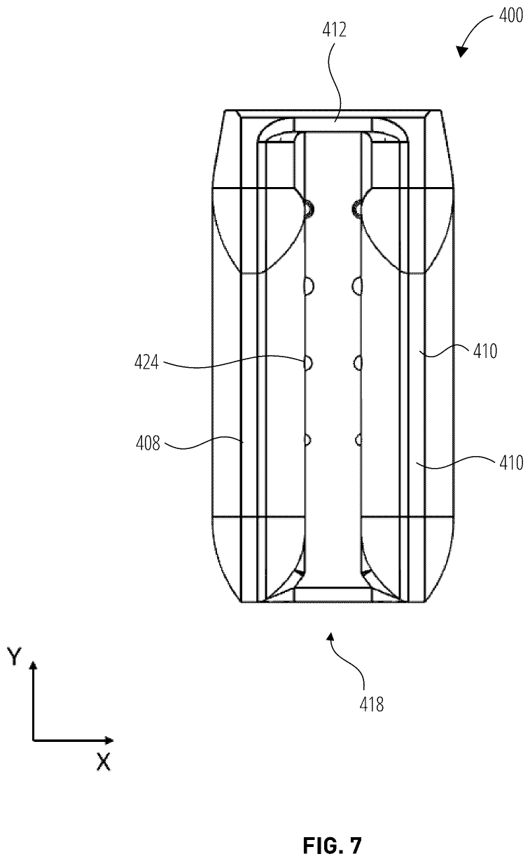

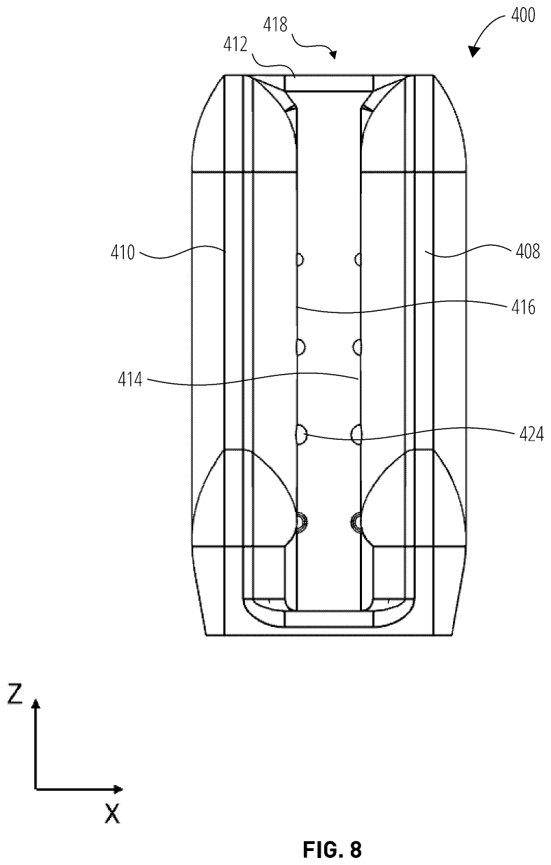

FIGS. 7 and 8 show an embodiment of a sign clip 400. The sign clip 400 includes a first side wall 408 and a second side wall 410. The first side wall 408 is connected to the second side wall 410 by one or more partitions 412. The first side wall 408 and the second side wall 410 are positioned to maintain a substantially constant gap therebetween. In some embodiments, the first side wall 408 and the second side wall 410 may not be positioned to have a substantially constant gap therebetween. The first side wall 408, the second side wall 410, and the partitions 412 may have a thickness within a range from about 0.5 mm to about 10 mm. In some embodiments, the thickness of the first side wall 408, the second side wall 410, and the partitions 412 may be within a range from about 4 mm to about 5 mm, or about 4.5 mm. The first side wall 408, the second side wall 410, and the partitions 412 may be formed of a plastic material such as a polylactic acid (PLA), polyethylene terephthalate (PET), or acrylonitrile butadiene styrene (ABS). The sign clip 400 may be formed from 3D printing, injection molding, compression molding, blow molding, or other manufacturing processes.

An interior surface 414 of the first side wall 408, an interior surface 416 of the second side wall 410, and the partition 412 may define a slot 418 corresponding to the gap between the first side wall 408 and the second side wall 410. The slot 418 is configured to temporarily receive and fix a portion of a sign relative to the sign clip 400. Conventional signs used in advertising have a thickness of about 4.5 mm, though some signs may have thicknesses up to about 10 mm. The slot 418 may have a width, defined by the distance between the first side wall 408 and the second side wall 410, within a range of from about 2 mm to about 10 mm. In some embodiments, the width varies (e.g., tapers) along the full depth of the slot 418. For example, a shallow region of the slot 418 adjacent outer edges of the side walls 408 and 410, distal to the partition 412, may be within a range of from about 5 mm to about 9 mm. The width may then decrease through a narrow intermediate region to within a range of from about 2 mm to about 3 mm, and the width may increase toward a deepest region of the slot 418, proximal to the partition 412, to within a range of from about 4 mm to about 10 mm. In some embodiments the slot 418 may have a width of about 9 mm distal to the partition 412, a width of about 2.5 mm at the intermediate region and a width of about 4.5 mm at the deepest region proximal to the partition 412. The narrow intermediate region of the slot 418 may compress a semi-rigid corrugated sign as the sign is inserted, and the sign may then elastically expand within the wider, deeper portion of the slot 418, providing frictional retention without damage to the sign.

Conventional signs used in advertising have a border around the edge of the signs with no advertisements. The slot 418 may have a depth, defined by a direction substantially perpendicular to the width of the slot 418, of about 10 mm. The depth of the slot 418 may facilitate the slots receiving a portion of the signs corresponding to the border of the sign. The sign clip 400 may be configured to blend into the border of the sign and be less noticeable when attached to the signs, thereby facilitating the advertising on the sign to retain attention of a viewer. The length of the slot 418, defined by a direction substantially perpendicular to both the width and the depth of the slot 418, may be about 60 mm. In some embodiments, the length of the slot 418 may be within a range from about 10 mm to about 80 mm.

Referring to FIG. 7, the direction of the width, the depth, and the length of the slot 418 may vary relative to a reference plane, such as an X-Y plane or other reference plane in any X-Y, X-Z, Y-Z plane or some combination thereof. For example, the length of the slot 418 may extend substantially in the X direction for a portion of the slot 418 and may shift to extend substantially in the Y direction for another portion of the slot 418. The direction of the width, the depth, and the length of the slot 418 remain constant relative to each other even when shifting relative to the X-Y plane, or another reference plane or reference grid, which may include a third direction, Z. Varying the direction of the width, the depth, and the length of the slot 418 relative to a reference plane facilitates connection of the sign clip 400 to a corner of a sign having a substantially 90 degree angle.

Each of the interior surfaces 414 and 416 may include one or more teeth 424. For example, each of the interior surfaces 414 and 416 may include one, two, three, four, five, or more teeth 424. The teeth 424 are configured to have a height, defined by the distance from the interior surface 414 or 416, of about 3.0 mm. In some embodiments, the teeth 424 may have a height within a range from about 0.65 mm to about 3 mm. The distance between the teeth 424 on the interior surface 414 and the opposing teeth 424 on the interior surface 416 may be in a range of from about 2 mm to about 4 mm. In some embodiments the distance between the teeth 424 on the interior surface 414 and the teeth 424 on the interior surface 416 may be about 2.75 mm. In some embodiments, the teeth 424 may be configured to have a hemispherical shape with a diameter of about 1.5 mm. In some embodiments the teeth 424 may have a diameter within a range of from about 0.5 mm to about 3 mm. The teeth 424 are configured to facilitate connection to the sign such that the sign will not slip out of the slot 418 unintentionally and will also not damage the sign when the sign is removed from the slot 418 intentionally. In some embodiments, the teeth 424 are located at a depth of about 2.25 mm into the slot 418 from an outer edge of the first side wall 408 and second side wall 410. In some embodiments the teeth 424 may be located at the narrowest portion of the slot 418.

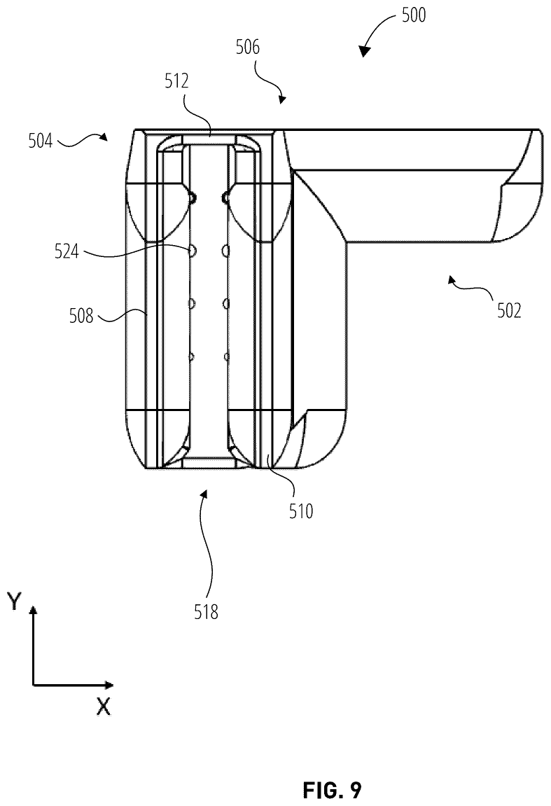

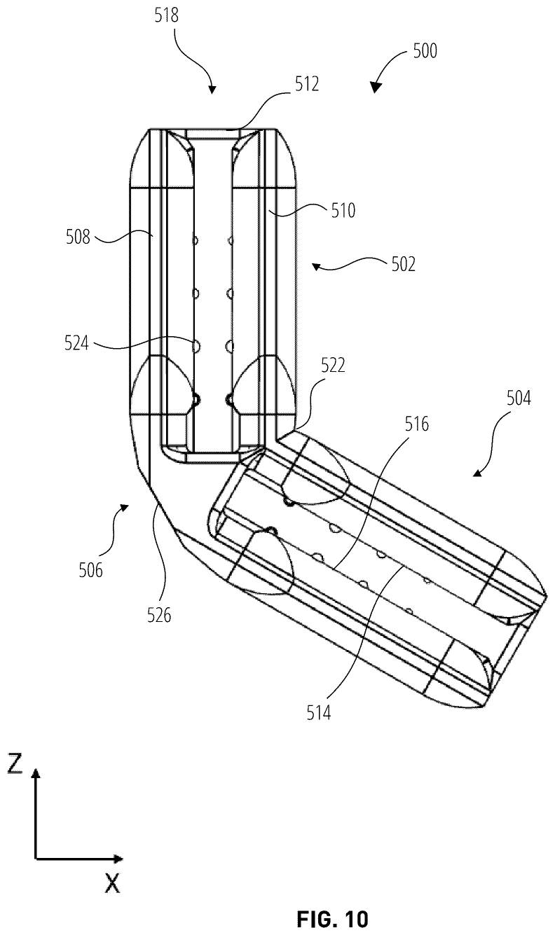

FIGS. 9 and 10 show an embodiment of a sign clip 500. The sign clip 500 may include a first portion 502 and a second portion 504 connected to the first portion 502 at a junction 506. Each of the first portion 502 and the second portion 504 includes a first side wall 508 and a second side wall 510. The first side wall 508 is connected to the second side wall 510 by one or more partitions 512. The first side wall 508 and the second side wall 510 are positioned to maintain a substantially constant gap therebetween. In some embodiments, the first side wall 508 and the second side wall 510 may not be positioned to have a substantially constant gap therebetween. The first side wall 508, the second side wall 510, and the partitions 512 may have a thickness within a range from about 0.5 mm to about 10 mm. In some embodiments, the thickness of the first side wall 508, the second side wall 510, and the partitions 512 may be within a range from about 4 mm to about 5 mm, or about 4.5 mm. The first side wall 508, the second side wall 510, and the partitions 512 may be formed of a plastic material such as a polylactic acid (PLA), polyethylene terephthalate (PET), or acrylonitrile butadiene styrene (ABS). The sign clip 500 may be formed from 3D printing, injection molding, compression molding, blow molding, or other manufacturing processes.

An interior surface 514 of the first side wall 508, an interior surface 516 of the second side wall 510, and the partitions 512 may define four slots 518 corresponding to the gap between the first side wall 508 and the second side wall 510. The slots 518 are configured to temporarily receive and fix a portion of a sign relative to the sign clip 500. Conventional signs used in advertising have a thickness of about 4.5 mm, though some signs may have thicknesses up to about 10 mm. The slots 518 may have a width, defined by the distance between the first side wall 508 and the second side wall 510, within a range of from about 2 mm to about 10 mm. In some embodiments, the width varies (e.g., tapers) along the full depth of each slot 518. For example, a shallow region of the slots 518 adjacent outer edges of the side walls 508 and 510, distal to the partition 512, may be within a range of from about 5 mm to about 9 mm. The width may then decrease through a narrow intermediate region to within a range of from about 2 mm to about 3 mm, and the width may increase toward a deepest region of the slots 518, proximal to the partition 512, to within a range of from about 4 mm to about 10 mm. In some embodiments the slots 518 may have a width of about 9 mm distal to the partition 512, a width of about 2.5 mm at the intermediate region and a width of about 4.5 mm at the deepest region proximal to the partition 512. The narrow intermediate region of the slots 518 may compress a semi-rigid corrugated sign as the sign is inserted, and the sign may then elastically expand within the wider, deeper portion of the slots 518, providing frictional retention without damage to the sign.

Conventional signs used in advertising have a border around the edge of the signs with no advertisements. The slots 518 may have a depth, defined by a direction substantially perpendicular to the width of the slots 518, of about 10 mm. The depth of the slots 518 may facilitate the slots receiving a portion of the signs corresponding to the border of the sign. The sign clip 500 may be configured to blend into the border of the sign and be less noticeable when attached to the signs, thereby facilitating the advertising on the sign to retain attention of a viewer. The length of the slots 518, defined by a direction substantially perpendicular to both the width and the depth of the slots 518, may be about 60 mm. In some embodiments, the length of the slots 518 may be within a range from about 10 mm to about 80 mm.

Referring to FIG. 9, the direction of the width, the depth, and the length of the slots 518 may vary relative to a reference plane, such as an X-Y plane or other reference plane in any X-Y, X-Z, Y-Z plane or some combination thereof. For example, the length of the slots 518 may extend substantially in the X direction for a portion of each of the slots 518 and may shift to extend substantially in the Y direction for another portion of each of the slots 518. The direction of the width, the depth, and the length of the slots 518 remain constant relative to each other even when shifting relative to the X-Y plane, or another reference plane or reference grid, which may include a third direction, Z. Varying the direction of the width, the depth, and the length of the slots 518 relative to a reference plane facilitates connection of the sign clip 500 to a corner of a sign having a substantially 90 degree angle.

Each of the interior surfaces 514 and 516 may include one or more teeth 524. For example, each of the interior surfaces 514 and 516 may include one, two, three, four, five, or more teeth 524. The teeth 524 are configured to have a height, defined by the distance from the interior surface 514 or 516, of about 3.0 mm. In some embodiments, the teeth 524 may have a height within a range from about 0.65 mm to about 3.0 mm. The distance between the teeth 524 on the interior surface 514 and the teeth 524 on the interior surface 516 may be in a range of from about 2 mm to about 4 mm. In some embodiments the distance between the teeth 524 on the interior surface 514 and the teeth 524 on the interior surface 516 may be about 2.75 mm. In some embodiments, the teeth 524 may be configured to have a hemispherical shape with a diameter of about 1.5 mm. In some embodiments the teeth 524 may have a diameter within a range of from about 0.5 mm to about 3 mm. The teeth 524 are configured to facilitate connection to the sign such that the sign will not slip out of the slots 518 unintentionally and will also not damage the sign when the sign is removed from the slots 518 intentionally. In some embodiments, teeth 524 are located at a depth of about 2.25 mm into the slots 518 from an outer edge of the first side wall 508 and second side wall 510. In some embodiments the teeth 524 may be located at the narrowest portion of the slots 518.

The junction 506 may include a corner 522 defining an angle (a) between the first side wall 508 of the first portion 502 and the second portion 504. The angle (a) may be within a range from about 15 degrees to about 175 degrees. In some embodiments, the angle (a) is within a range from about 45 degrees to about 145 degrees or within a range from about 75 degrees to about 115 degrees. In some embodiments, the angle (a) is about 60 degrees, about 90 degrees, or about 180 degrees. The junction 506 may also include a third side wall 526 connecting the second side wall 510 of the first portion 502 and the second portion 504. In some embodiments, the corner 522 may be adjacent to or connected to the third side wall 526. The third side wall 526 may also partially define each of the slots 518.

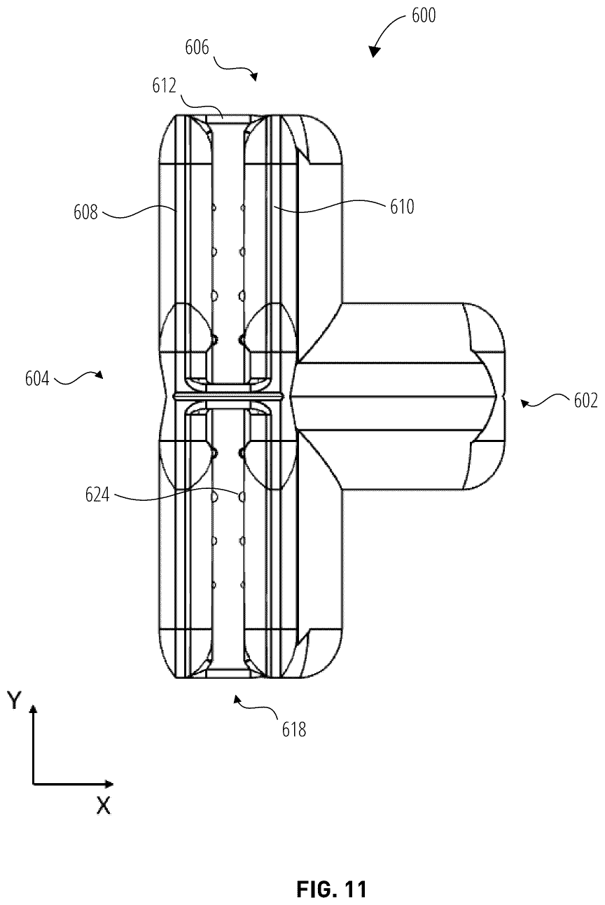

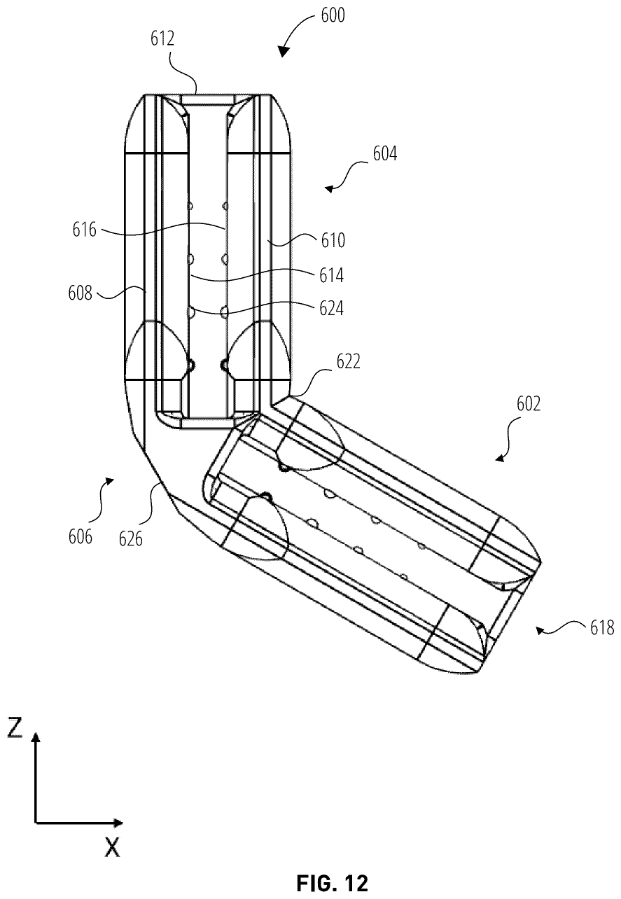

FIGS. 11 and 12 show an embodiment of a sign clip 600. The sign clip 600 may include a first portion 602 and a second portion 604 connected to the first portion 602 at a junction 606. Each of the first portion 602 and the second portion 604 includes a first side wall 608 and a second side wall 610. The first side wall 608 is connected to the second side wall 610 by one or more partitions 612. The first side wall 608 and the second side wall 610 are positioned to maintain a substantially constant gap therebetween. In some embodiments, the first side wall 608 and the second side wall 610 may not be positioned to have a substantially constant gap therebetween. The first side wall 608, the second side wall 610, and the partitions 612 may have a thickness within a range from about 0.5 mm to about 10 mm. In some embodiments, the thickness of the first side wall 608, the second side wall 610, and the partitions 612 may be within a range from about 4 mm to about 5 mm, or about 4.5 mm. The first side wall 608, the second side wall 610, and the partitions 612 may be formed of a plastic material such as a polylactic acid (PLA), polyethylene terephthalate (PET), or acrylonitrile butadiene styrene (ABS). The sign clip 600 may be formed from 3D printing, injection molding, compression molding, blow molding, or other manufacturing processes.

An interior surface 614 of the first side wall 608, an interior surface 616 of the second side wall 610, and the partitions 612 may define four slots 618 corresponding to the gap between the first side wall 608 and the second side wall 610. The slots 618 are configured to temporarily receive and fix a portion of a sign relative to the sign clip 600. Conventional signs used in advertising have a thickness of about 4.5 mm, though some signs may have thicknesses up to about 10 mm. The slots 618 may have a width, defined by the distance between the first side wall 608 and the second side wall 610, within a range of from about 2 mm to about 10 mm. In some embodiments, the width varies (e.g., tapers) along the full depth of each slot 618. For example, a shallow region of the slots 618 adjacent outer edges of the side walls 608 and 610, distal to the partition 612, may be within a range of from about 5 mm to about 9 mm. The width may then decrease through a narrow intermediate region to within a range of from about 2 mm to about 3 mm, and the width may increase toward a deepest region of the slots 618, proximal to the partition 612, to within a range of from about 4 mm to about 10 mm. In some embodiments the slots 618 may have a width of about 9 mm distal to the partition 612, a width of about 2.5 mm at the intermediate region and a width of about 4.5 mm at the deepest region proximal to the partition 612. The narrow intermediate region of the slots 618 may compress a semi-rigid corrugated sign as the sign is inserted, and the sign may then elastically expand within the wider, deeper portion of the slots 618, providing frictional retention without damage to the sign.

Conventional signs used in advertising have a border around the edge of the signs with no advertisements. The slots 618 may have a depth, defined by a direction substantially perpendicular to the width of the slots 618, of about 10 mm. The depth of the slots 618 may facilitate the slots receiving a portion of the signs corresponding to the border of the sign. The sign clip 600 may be configured to blend into the border of the sign and be less noticeable when attached to the signs, thereby facilitating the advertising on the sign to retain attention of a viewer. The length of the slots 618, defined by a direction substantially perpendicular to both the width and the depth of the slots 618, may be about 60 mm. In some embodiments, the length of the slots 618 may be within a range from about 10 mm to about 80 mm.

Referring to FIG. 11, the direction of the width, the depth, and the length of the slots 618 may vary relative to a reference plane, such as an X-Y plane or other reference plane in any X-Y, X-Z, Y-Z plane or some combination thereof. For example, the length of the slots 618 may extend substantially in the X direction for a portion of each of the slots 618 and may shift to extend substantially in the Y direction for another portion of each of the slots 618. The direction of the width, the depth, and the length of the slots 618 remain constant relative to each other even when shifting relative to the X-Y plane, or another reference plane or reference grid, which may include a third direction, Z. Varying the direction of the width, the depth, and the length of the slots 618 relative to a reference plane facilitates connection of the sign clip 600 to a corner of a sign having a substantially 90 degree angle.

Each of the interior surfaces 614 and 616 may include one or more teeth 624. For example, each of the interior surfaces 614 and 616 may include one, two, three, four, five, or more teeth 624. The teeth 624 are configured to have a height, defined by the distance from the interior surface 614 or 616, of about 3.0 mm. In some embodiments, the teeth 624 may have a height within a range from about 0.65 mm to about 3.0 mm. The distance between the teeth 624 on the interior surface 614 and the teeth 624 on the interior surface 616 may be in a range of from about 2 mm to about 4 mm. In some embodiments the distance between the teeth 624 on the interior surface 614 and the teeth 624 on the interior surface 616 may be about 2.75 mm. In some embodiments, the teeth 624 may be configured to have a hemispherical shape with a diameter of about 1.5 mm. In some embodiments the teeth 624 may have a diameter within a range of from about 0.5 mm to about 3 mm. The teeth 624 are configured to facilitate connection to the sign such that the sign will not slip out of the slots 618 unintentionally and will also not damage the sign when the sign is removed from the slots 618 intentionally. In some embodiments, teeth 624 are located at a depth of about 2.25 mm into the slots 618 from an outer edge of the first side wall 608 and second side wall 610. In some embodiments the teeth 624 may be located at the narrowest portion of the slots 618.

The junction 606 may include a corner 622 defining an angle (a) between the first side wall 608 of the first portion 602 and the second portion 604. The angle (a) may be within a range from about 15 degrees to about 175 degrees. In some embodiments, the angle (a) is within a range from about 45 degrees to about 145 degrees or within a range from about 75 degrees to about 115 degrees. In some embodiments, the angle (a) is about 60 degrees, about 90 degrees, or about 180 degrees. The junction 606 may also include a third side wall 626 connecting the second side wall 610 of the first portion 602 and the second portion 604. In some embodiments, the corner 622 may be adjacent to or connected to the third side wall 626. The third side wall 626 may also partially define each of the slots 618.

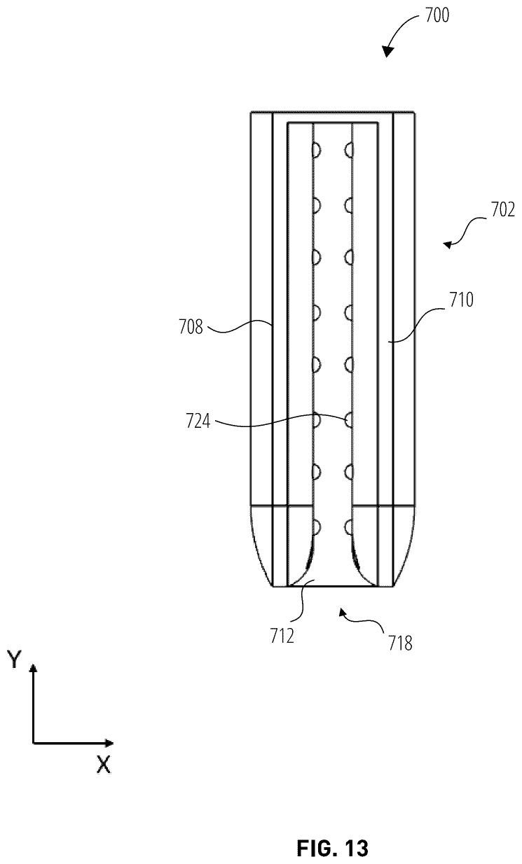

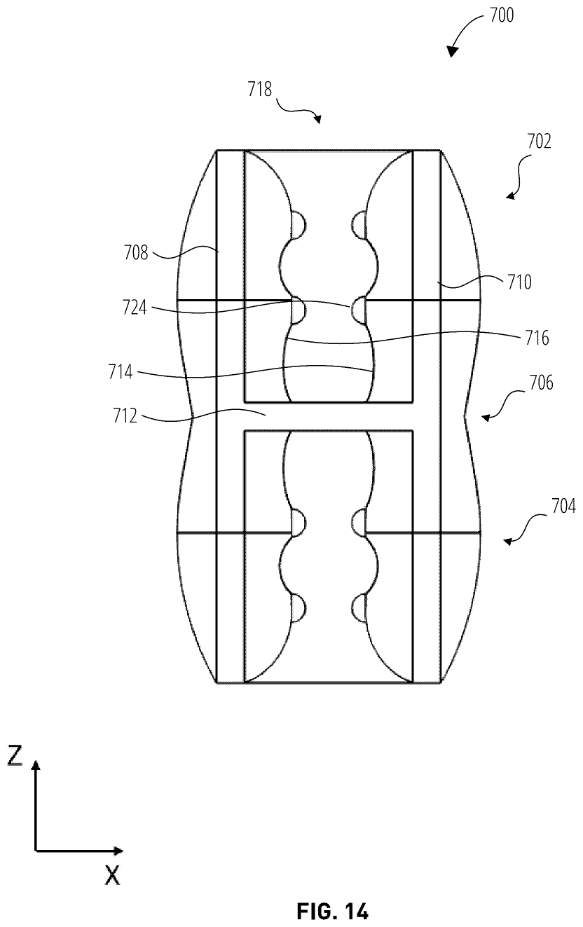

FIGS. 13 and 14 show an embodiment of a sign clip 700. The sign clip 700 may include a first portion 702 and a second portion 704 that meet at a junction 706. Each of the first portion 702 and the second portion 704 includes a first side wall 708 and a second side wall 710. The first side wall 708 is connected to the second side wall 710 by one or more partitions 712. The first side wall 708 and the second side wall 710 are positioned to maintain a substantially constant gap therebetween. In some embodiments, the first side wall 708 and the second side wall 710 may not be positioned to have a substantially constant gap therebetween. The first side wall 708, the second side wall 710, and the partitions 712 may have a thickness within a range from about 0.5 mm to about 10 mm. In some embodiments, the thickness of the first side wall 708, the second side wall 710, and the partitions 712 may be within a range from about 4 mm to about 5 mm, or about 4.5 mm. The first side wall 708, the second side wall 710, and the partitions 712 may be formed of a plastic material such as a polylactic acid (PLA), polyethylene terephthalate (PET), or acrylonitrile butadiene styrene (ABS). The sign clip 700 may be formed from 3D printing, injection molding, compression molding, blow molding, or other manufacturing processes.

An interior surface 714 of the first side wall 708, an interior surface 716 of the second side wall 710, and the partitions 712 may define two slots 718 corresponding to the gap between the first side wall 708 and the second side wall 710. The slots 718 may have a width, defined by the distance between the interior surfaces 714 and 716, within a range of from about 2 mm to about 10 mm. In some embodiments, the width varies (e.g., tapers) along the full depth of each slot 718. For example, a shallow region of the slots 718 adjacent the outer edges of the side walls 708 and 710, distal to the partitions 712, may be within a range of from about 5 mm to about 9 mm. The width may then decrease through a first constricted region to within a range of from about 2 mm to about 3 mm. The width may increase across a central pocket region to within a range of from about 6 mm to about 9 mm, decrease again through a second constricted region to within a range of from about 2 mm to about 3 mm, and finally increase toward a terminal pocket, proximal to the partitions 712, to within a range of from about 4 mm to about 10 mm. In some embodiments the slots 718 may have a width of about 9 mm distal to the partitions 712, a width of about 2.5 mm at each constricted region, a width of about 8 mm at the central pocket, and a width of about 4.5 mm at the terminal pocket proximal to the partitions 712. The alternating constricted and pocket regions compress a semi-rigid corrugated sign as it is inserted and allow the sign to elastically expand within the wider regions, providing frictional retention without damaging the sign.

Conventional corrugated signs used in advertising have a thickness of about 4.5 mm, though some signs may have thicknesses up to about 10 mm. Accordingly, each slot 718 may have a width of about 5 mm to about 9 mm in the entrance region, narrow to about 2 mm to about 4 mm at the first constriction, expand to about 6 mm to about 9 mm in the central pocket, narrow again to about 2 mm to about 4 mm at the second constriction, and widen to about 4 mm to about 6 mm in the terminal pocket.

Each slot 718 may have a depth, defined by a direction substantially perpendicular to its width, of about 20 mm, such as within a range of from about 10 mm to about 40 mm. The depth of the slots 718 may facilitate the slots receiving a portion of the signs corresponding to the border of the sign. The sign clip 700 may be configured to blend into the border of the sign and be less noticeable when attached to the signs, thereby facilitating the advertising on the sign to retain attention of a viewer. The length of each slot 718, measured along the Y-axis, may be about 40 mm, such as within a range of from about 10 mm to about 60 mm. The direction of the width, the depth, and the length of the slots 718 may remain constant relative to a reference plane, such as an X-Y plane or other reference plane in any X-Y, X-Z, Y-Z plane or some combination thereof.

Each of the interior surfaces 714 and 716 may include one or more teeth 724. For example, each of the interior surfaces 714 and 716 may include one, two, three, four, five, or more teeth 724. In some embodiments each of the interior surfaces 714 and 716 may include two rows of teeth 724. With reference to FIG. 14, two rows of teeth 724 project inwardly from the interior surfaces 714, 716—one row at each constriction region. Each tooth 724 may have a height within a range of from about 0.65 mm to about 3.0 mm. The distance between opposing teeth 724 may be within a range of from about 2 mm to about 4 mm, such as about 2.75 mm, and each tooth 724 may have a hemispherical profile with a diameter within a range of from about 0.5 mm to about 3 mm, for example about 1.5 mm. The teeth 724 are configured to facilitate connection to the sign such that the sign will not slip out of the slots 718 unintentionally and will also not damage the sign when the sign is removed from the slots 718 intentionally. In some embodiments, a first row of teeth 724 is located at a depth of about 2.25 mm, such as within a range of 1 mm to 5 mm, into the slots 718 from an outer edge of the first side wall 708 and second side wall 710, and a second row of teeth may be located at a depth of about 5 mm, such as within a range of from about 3 mm to about 7 mm, into the slots 718.

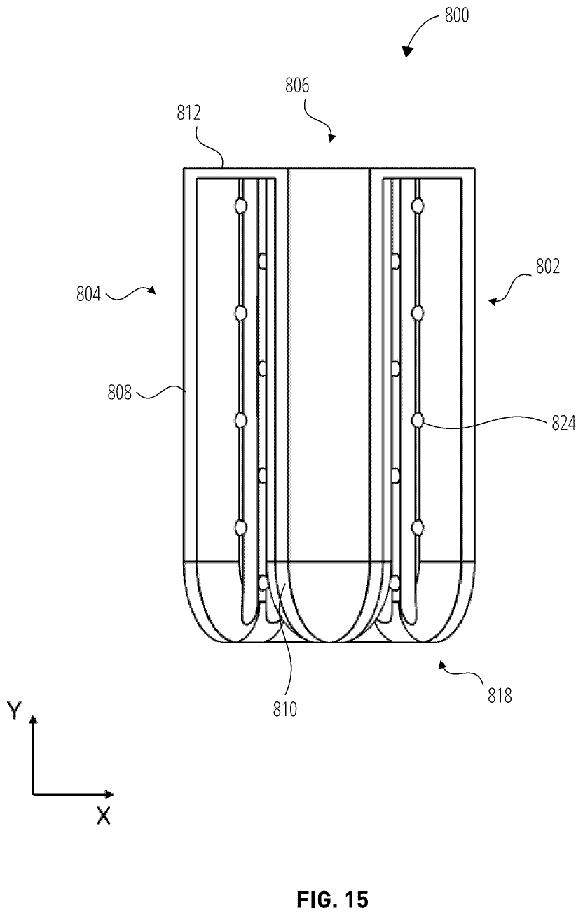

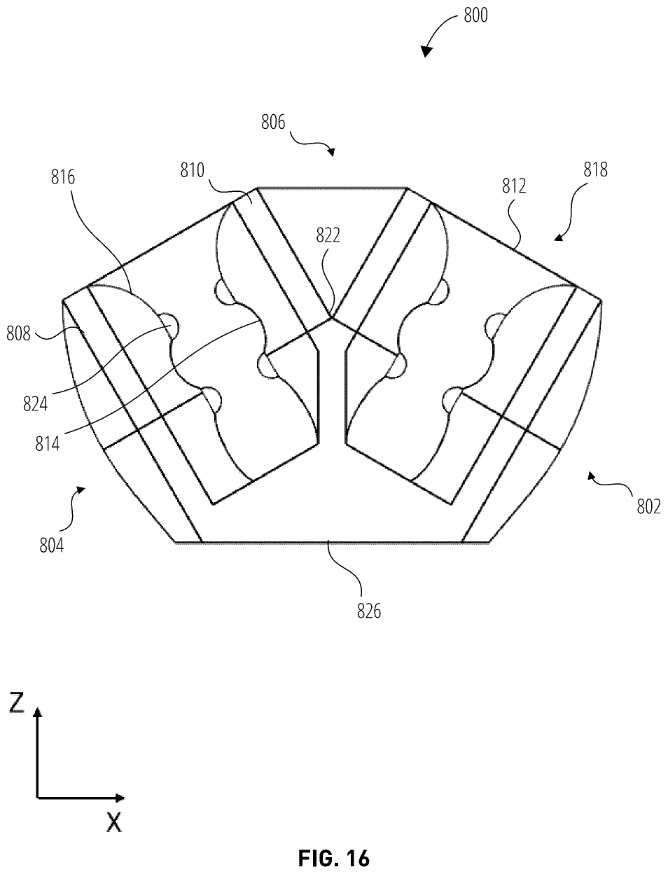

FIGS. 15 and 16 show an embodiment of a sign clip 800. The sign clip 800 may include a first portion 802 and a second portion 804 that meet at a junction 806. Each of the first portion 802 and the second portion 804 includes a first side wall 808 and a second side wall 810. The first side wall 808 is connected to the second side wall 810 by one or more partitions 812. The first side wall 808 and the second side wall 810 are positioned to maintain a substantially constant gap therebetween. In some embodiments, the first side wall 808 and the second side wall 810 may not be positioned to have a substantially constant gap therebetween. The first side wall 808, the second side wall 810, and the partitions 812 may have a thickness within a range from about 0.5 mm to about 10 mm. In some embodiments, the thickness of the first side wall 808, the second side wall 810, and the partitions 812 may be within a range from about 4 mm to about 5 mm, or about 4.5 mm. The first side wall 808, the second side wall 810, and the partitions 812 may be formed of a plastic material such as polylactic acid (PLA), polyethylene terephthalate (PET), or acrylonitrile butadiene styrene (ABS). The sign clip 800 may be formed by 3-D printing, injection molding, compression molding, blow molding, or other manufacturing processes.

An interior surface 814 of the first side wall 808, an interior surface 816 of the second side wall 810, and the partitions 812 may define two slots 818 corresponding to the gap between the first side wall 808 and the second side wall 810. The slots 818 may have a width, defined by the distance between the interior surfaces 814 and 816, within a range of from about 2 mm to about 10 mm. In some embodiments, the width varies (e.g., tapers) along the full depth of each slot 818. For example, a shallow region of the slots 818 adjacent the outer edges of the side walls 808 and 810, distal to the partitions 812, may be within a range of from about 5 mm to about 9 mm. The width may then decrease through a first constricted region to within a range of from about 2 mm to about 3 mm. The width may increase across a central pocket region to within a range of from about 6 mm to about 9 mm, decrease again through a second constricted region to within a range of from about 2 mm to about 3 mm, and finally increase toward a terminal pocket, proximal to the partitions 812, to within a range of from about 4 mm to about 10 mm. In some embodiments the slots 818 may have a width of about 9 mm distal to the partitions 812, a width of about 2.5 mm at each constricted region, a width of about 8 mm at the central pocket, and a width of about 4.5 mm at the terminal pocket proximal to the partitions 812. The alternating constricted and pocket regions compress a semi-rigid corrugated sign as it is inserted and allow the sign to elastically expand within the wider regions, providing frictional retention without damaging the sign.

Conventional corrugated signs used in advertising have a thickness of about 4.5 mm, though some signs may have thicknesses up to about 10 mm. Accordingly, each slot 818 may have a width of about 5 mm to about 9 mm in the entrance region, narrow to about 2 mm to about 4 mm at the first constriction, expand to about 6 mm to about 9 mm in the central pocket, narrow again to about 2 mm to about 4 mm at the second constriction, and widen to about 4 mm to about 6 mm in the terminal pocket.

Each slot 818 may have a depth, measured perpendicular to its width, of about 20 mm, such as within a range of from about 10 mm to about 40 mm. The depth enables the slot to receive the border portion of a sign. The sign clip 800 may blend into the border and be less noticeable when attached, allowing the advertising message to retain the viewer's attention. The length of each slot 818, measured along the Y-axis, may be about 40 mm, such as within a range of from about 10 mm to about 60 mm. The directions of width, depth, and length may remain constant relative to a reference plane, such as an X-Y plane or any combination of X-Y, X-Z, or Y-Z planes.

Each of the interior surfaces 814 and 816 may include one or more teeth 824. For example, each interior surface may include one to five or more teeth 824, and in some embodiments two rows of teeth 824 are provided, one at each constriction region. Each tooth 824 may have a height within a range of from about 0.65 mm to about 3.0 mm. The distance between opposing teeth 824 may be within a range of from about 2 mm to about 4 mm, such as about 2.75 mm. Each tooth 824 may have a hemispherical profile with a diameter within a range of from about 0.5 mm to about 3 mm, for example about 1.5 mm. The teeth 824 grip the sign so that it will not slip out of the slots 818 unintentionally yet will not be damaged when intentionally removed. In some embodiments, a first row of teeth 824 is located at a depth of about 2.25 mm, such as within a range of from about 1 mm to about 5 mm, from the outer edge of the side walls 808 and 810, and a second row of teeth 824 is located at a depth of about 5 mm, such as within a range of from about 3 mm to about 7 mm, into the slots 818.

The junction 806 may include a corner 822 defining an angle (a) between the first side wall 808 of the first portion 802 and the second portion 804. The angle (a) may be within a range from about 15 degrees to about 175 degrees. In some embodiments, the angle (a) is within a range from about 45 degrees to about 145 degrees or within a range from about 75 degrees to about 115 degrees. In some embodiments, the angle (a) is about 60 degrees, about 90 degrees, or about 180 degrees. The junction 806 may also include a third side wall 826 connecting the second side wall 810 of the first portion 802 and the second portion 804. In some embodiments, the corner 822 may be adjacent to or connected to the third side wall 826. The third side wall 826 may also partially define each of the slots 818.

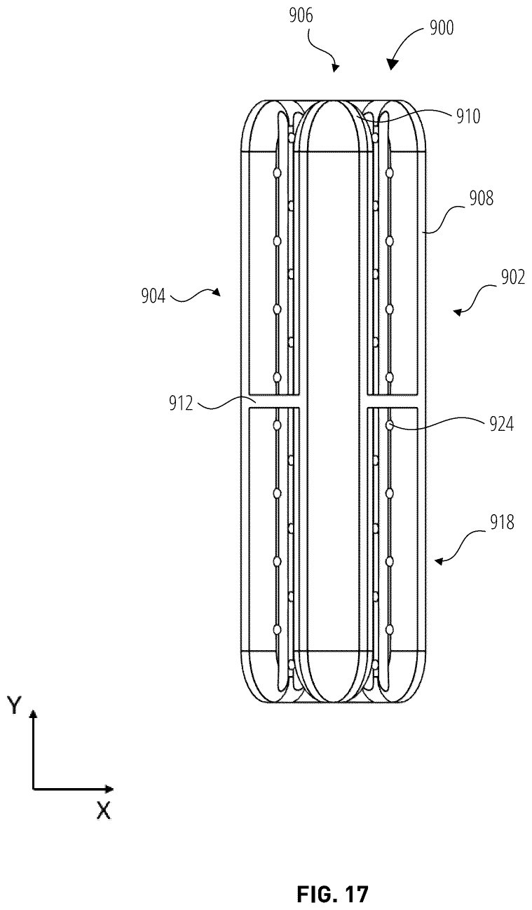

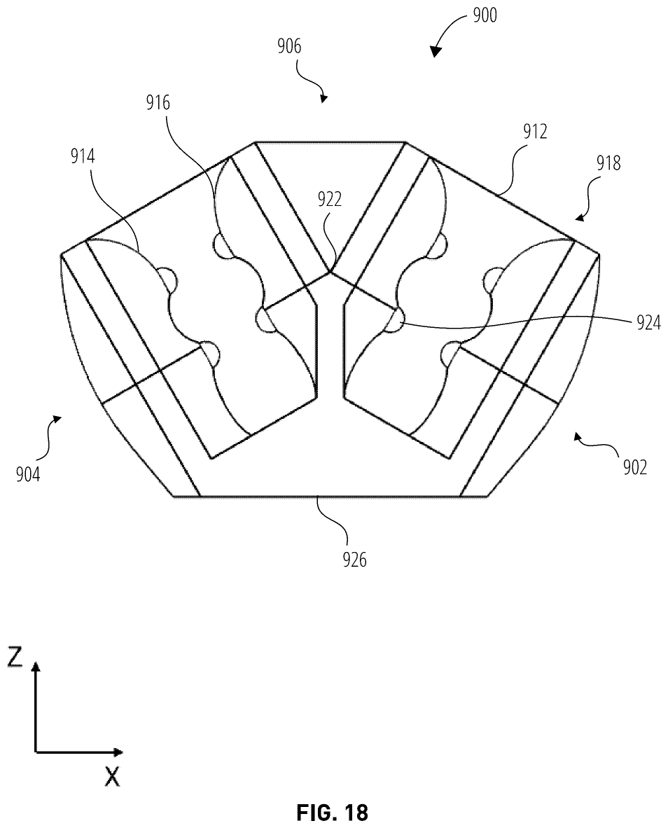

FIGS. 17 and 18 show an embodiment of a sign clip 900. The sign clip 900 may include a first portion 902 and a second portion 904 that meet at a junction 906. Each of the first portion 902 and the second portion 904 includes a first side wall 908 and a second side wall 910. The first side wall 908 is connected to the second side wall 910 by one or more partitions 912. The first side wall 908 and the second side wall 910 are positioned to maintain a substantially constant gap therebetween. In some embodiments, the first side wall 908 and the second side wall 910 may not be positioned to have a substantially constant gap therebetween. The first side wall 908, the second side wall 910, and the partitions 912 may have a thickness within a range from about 0.5 mm to about 10 mm. In some embodiments, the thickness of the first side wall 908, the second side wall 910, and the partitions 912 may be within a range from about 4 mm to about 5 mm, or about 4.5 mm. The first side wall 908, the second side wall 910, and the partitions 912 may be formed of a plastic material such as polylactic acid (PLA), polyethylene terephthalate (PET), or acrylonitrile butadiene styrene (ABS). The sign clip 900 may be formed by 3-D printing, injection molding, compression molding, blow molding, or other manufacturing processes.

An interior surface 914 of the first side wall 908, an interior surface 916 of the second side wall 910, and the partitions 912 may define four slots 918 corresponding to the gap between the first side wall 908 and the second side wall 910. The slots 918 may have a width, defined by the distance between the interior surfaces 914 and 916, within a range of from about 2 mm to about 10 mm. In some embodiments, the width varies (e.g., tapers) along the full depth of each slot 918. For example, a shallow region of the slots 918 adjacent the outer edges of the side walls 908 and 910, distal to the partitions 912, may be within a range of from about 5 mm to about 9 mm. The width may then decrease through a first constricted region to within a range of from about 2 mm to about 3 mm. The width may increase across a central pocket region to within a range of from about 6 mm to about 9 mm, decrease again through a second constricted region to within a range of from about 2 mm to about 3 mm, and finally increase toward a terminal pocket, proximal to the partitions 912, to within a range of from about 4 mm to about 10 mm. In some embodiments the slots 918 may have a width of about 9 mm distal to the partitions 912, a width of about 2.5 mm at each constricted region, a width of about 8 mm at the central pocket, and a width of about 4.5 mm at the terminal pocket proximal to the partitions 912. The alternating constricted and pocket regions compress a semi-rigid corrugated sign as it is inserted and allow the sign to elastically expand within the wider regions, providing frictional retention without damaging the sign.

Conventional corrugated signs used in advertising have a thickness of about 4.5 mm, though some signs may have thicknesses up to about 10 mm. Accordingly, each slot 918 may have a width of about 5 mm to about 9 mm in the entrance region, narrow to about 2 mm to about 4 mm at the first constriction, expand to about 6 mm to about 9 mm in the central pocket, narrow again to about 2 mm to about 4 mm at the second constriction, and widen to about 4 mm to about 6 mm in the terminal pocket.

Each slot 918 may have a depth, measured perpendicular to its width, of about 20 mm, such as within a range of from about 10 mm to about 40 mm. The depth enables the slot to receive the border portion of a sign. The sign clip 900 may blend into the border and be less noticeable when attached, allowing the advertising message to retain the viewer's attention. The length of each slot 918, measured along the Y-axis, may be about 40 mm, such as within a range of from about 10 mm to about 60 mm. The directions of width, depth, and length may remain constant relative to a reference plane, such as an X-Y plane or any combination of X-Y, X-Z, or Y-Z planes.

Each of the interior surfaces 914 and 916 may include one or more teeth 924. For example, each interior surface may include one to five or more teeth 924, and in some embodiments two rows of teeth 924 are provided, one at each constriction region. Each tooth 924 may have a height within a range of from about 0.65 mm to about 3.0 mm. The distance between opposing teeth 924 may be within a range of from about 2 mm to about 4 mm, such as about 2.75 mm. Each tooth 924 may have a hemispherical profile with a diameter within a range of from about 0.5 mm to about 3 mm, for example about 1.5 mm. The teeth 924 grip the sign so that it will not slip out of the slots 918 unintentionally yet will not be damaged when intentionally removed. In some embodiments, a first row of teeth 924 is located at a depth of about 2.25 mm, such as within a range of from about 1 mm to about 5 mm, from the outer edge of the side walls 908 and 910, and a second row of teeth 924 is located at a depth of about 5 mm, such as within a range of from about 3 mm to about 7 mm, into the slots 918.

The junction 906 may include a corner 922 defining an angle (a) between the first side wall 908 of the first portion 902 and the second portion 904. The angle (a) may be within a range from about 15 degrees to about 175 degrees. In some embodiments, the angle (a) is within a range from about 45 degrees to about 145 degrees or within a range from about 75 degrees to about 115 degrees. In some embodiments, the angle (a) is about 60 degrees, about 90 degrees, or about 180 degrees. The junction 906 may also include a third side wall 926 connecting the second side wall 910 of the first portion 902 and the second portion 904. In some embodiments, the corner 922 may be adjacent to or connected to the third side wall 926. The third side wall 926 may also partially define each of the slots 918.

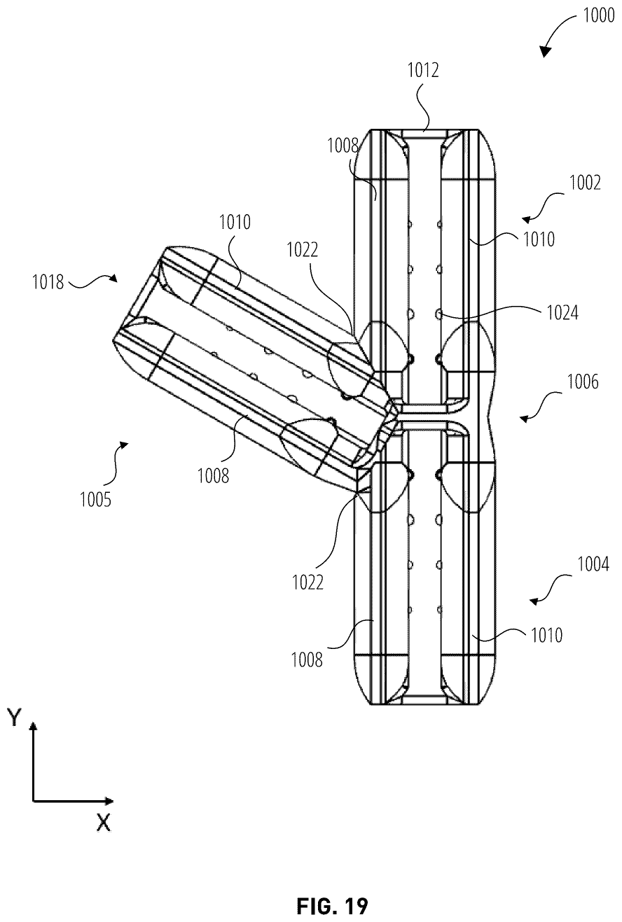

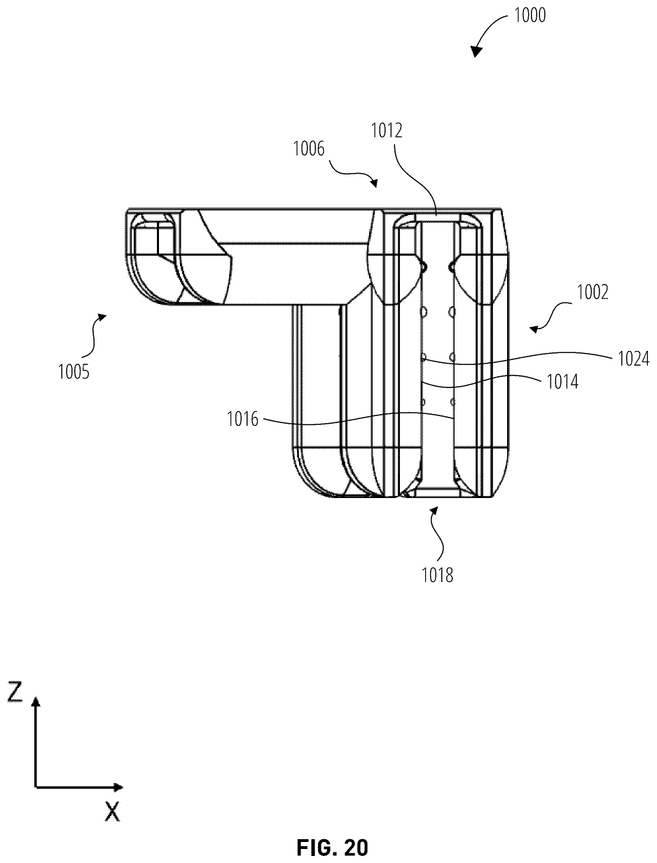

FIGS. 19 and 20 show an embodiment of a sign clip 1000. The sign clip 1000 may include a first portion 1002, a second portion 1004, and a third portion 1005 connected to one another at a junction 1006. Each of the first portion 1002, the second portion 1004, and the third portion 1005 includes a first side wall 1008 and a second side wall 1010. The first side wall 1008 is connected to the second side wall 1010 by one or more partitions 1012. The first side wall 1008 and the second side wall 1010 are positioned to maintain a substantially constant gap therebetween. In some embodiments, the first side wall 1008 and the second side wall 1010 may not be positioned to have a substantially constant gap therebetween. The first side wall 1008, the second side wall 1010, and the partitions 1012 may have a thickness within a range from about 0.5 mm to about 10 mm. In some embodiments, the thickness of the first side wall 1008, the second side wall 1010, and the partitions 1012 may be within a range from about 4 mm to about 5 mm, or about 4.5 mm. The first side wall 1008, the second side wall 1010, and the partitions 1012 may be formed of a plastic material such as a polylactic acid (PLA), polyethylene terephthalate (PET), or acrylonitrile butadiene styrene (ABS). The sign clip 1000 may be formed from 3-D printing, injection molding, compression molding, blow molding, or other manufacturing processes.

An interior surface 1014 of the first side wall 1008, an interior surface 1016 of the second side wall 1010, and the partitions 1012 may define three slots 1018 corresponding to the gap between the first side wall 1008 and the second side wall 1010. The slots 1018 are configured to temporarily receive and fix a portion of a sign relative to the sign clip 1000. Conventional signs used in advertising have a thickness of about 4.5 mm, though some signs may have thicknesses up to about 10 mm. The slots 1018 may have a width, defined by the distance between the first side wall 1008 and the second side wall 1010, within a range of from about 2 mm to about 10 mm. In some embodiments, the width varies (e.g., tapers) along the full depth of each slot 1018. For example, a shallow region of the slots 1018 adjacent outer edges of the side walls 1008 and 1010, distal to the partition 1012, may be within a range of from about 5 mm to about 9 mm. The width may then decrease through a narrow intermediate region to within a range of from about 2 mm to about 3 mm, and the width may increase toward a deepest region of the slots 1018, proximal to the partition 1012, to within a range of from about 4 mm to about 10 mm. In some embodiments the slots 1018 may have a width of about 9 mm distal to the partition 1012, a width of about 2.5 mm at the intermediate region, and a width of about 4.5 mm at the deepest region proximal to the partition 1012. The narrow intermediate region of the slots 1018 may compress a semi-rigid corrugated sign as the sign is inserted, and the sign may then elastically expand within the wider, deeper portion of the slots 1018, providing frictional retention without damage to the sign.

Conventional signs used in advertising have a border around the edge of the signs with no advertisements. The slots 1018 may have a depth, defined by a direction substantially perpendicular to the width of the slots 1018, of about 10 mm. The depth of the slots 1018 may facilitate the slots receiving a portion of the signs corresponding to the border of the sign. The sign clip 1000 may be configured to blend into the border of the sign and be less noticeable when attached to the signs, thereby facilitating the advertising on the sign to retain attention of a viewer. The length of the slots 1018, defined by a direction substantially perpendicular to both the width and the depth of the slots 1018, may be about 60 mm. In some embodiments, the length of the slots 1018 may be within a range from about 10 mm to about 80 mm.

Referring to FIG. 19, the direction of the width, the depth, and the length of the slots 1018 may vary relative to a reference plane, such as an X-Y plane or other reference plane in any X-Y, X-Z, Y-Z plane or some combination thereof. For example, the length of the slots 1018 may extend substantially in the X direction for a portion of each of the slots 1018 and may shift to extend substantially in the Y direction for another portion of each of the slots 1018. The direction of the width, the depth, and the length of the slots 1018 remain constant relative to each other even when shifting relative to the X-Y plane, or another reference plane or reference grid, which may include a third direction, Z. Varying the direction of the width, the depth, and the length of the slots 1018 relative to a reference plane facilitates connection of the sign clip 1000 to a corner of a sign having a substantially 90-degree angle.

Each of the interior surfaces 1014 and 1016 may include one or more teeth 1024. For example, each of the interior surfaces 1014 and 1016 may include one, two, three, four, five, or more teeth 1024. The teeth 1024 are configured to have a height, defined by the distance from the interior surface 1014 or 1016, of about 3.0 mm. In some embodiments, the teeth 1024 may have a height within a range from about 0.65 mm to about 3.0 mm. The distance between the teeth 1024 on the interior surface 1014 and the teeth 1024 on the interior surface 1016 may be in a range of from about 2 mm to about 4 mm. In some embodiments the distance between the teeth 1024 on the interior surface 1014 and the teeth 1024 on the interior surface 1016 may be about 2.75 mm. In some embodiments, the teeth 1024 may be configured to have a hemispherical shape with a diameter of about 1.5 mm. In some embodiments the teeth 1024 may have a diameter within a range of from about 0.5 mm to about 3 mm. The teeth 1024 are configured to facilitate connection to the sign such that the sign will not slip out of the slots 1018 unintentionally and will also not damage the sign when the sign is removed from the slots 1018 intentionally. In some embodiments, teeth 1024 are located at a depth of about 2.25 mm into the slots 1018 from an outer edge of the first side wall 1008 and second side wall 1010. In some embodiments the teeth 1024 may be located at the narrowest portion of the slots 1018.

The junction 1006 may include at least two corners 1022 defining at least two angles (α and β). Angle α is defined between the first side wall 1008 of the first portion 1002 and the second side wall 1010 of the third portion 1005. Angle β is defined between the first side wall 1008 of the third portion 1005 and the first side wall 1008 of the second portion 1004. The angles (α and/or β) may be within a range from about 15 degrees to about 175 degrees. In some embodiments, the angles (α and/or β) are within a range from about 45 degrees to about 145 degrees or within a range from about 75 degrees to about 115 degrees. In some embodiments, the angles (α and/or β) are about 90 degrees. In some embodiments, the angles (α and β) add up to 180 degrees.

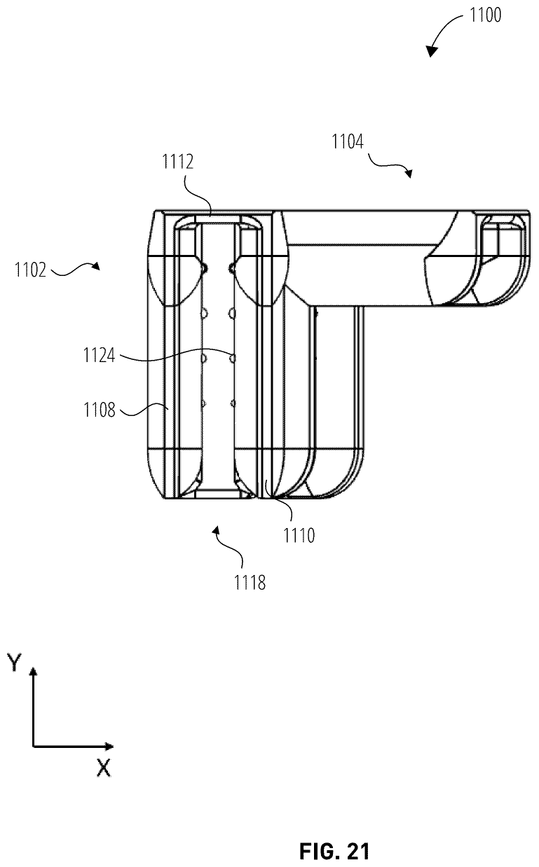

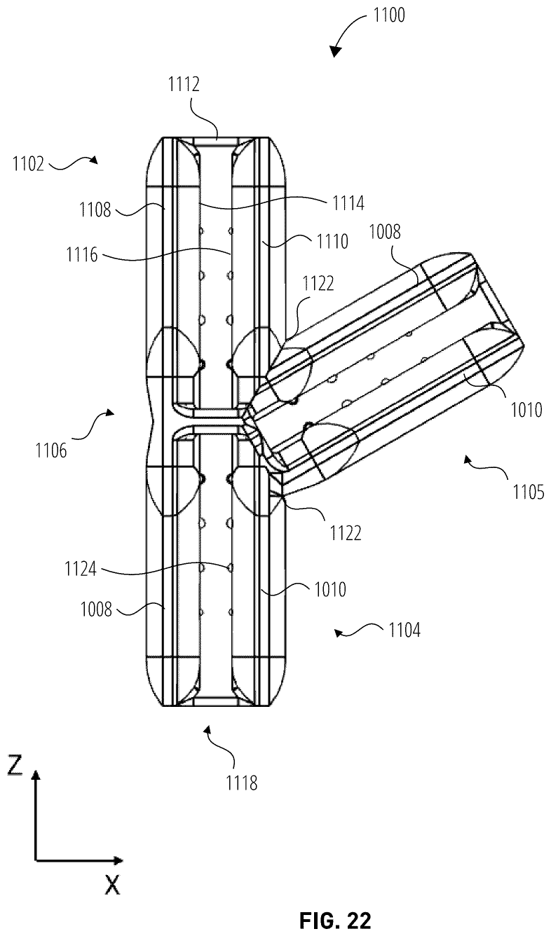

FIGS. 21 and 22 show an embodiment of a sign clip 1100. The sign clip 1100 may include a first portion 1102, a second portion 1104, and a third portion 1105 connected to one another at a junction 1106. Each of the first portion 1102, the second portion 1104, and the third portion 1105 includes a first side wall 1108 and a second side wall 1110. The first side wall 1108 is connected to the second side wall 1110 by one or more partitions 1112. The first side wall 1108 and the second side wall 1110 are positioned to maintain a substantially constant gap therebetween. In some embodiments, the first side wall 1108 and the second side wall 1110 may not be positioned to have a substantially constant gap therebetween. The first side wall 1108, the second side wall 1110, and the partitions 1112 may have a thickness within a range from about 0.5 mm to about 10 mm. In some embodiments, the thickness of the first side wall 1108, the second side wall 1110, and the partitions 1112 may be within a range from about 4 mm to about 5 mm, or about 4.5 mm. The first side wall 1108, the second side wall 1110, and the partitions 1112 may be formed of a plastic material such as a polylactic acid (PLA), polyethylene terephthalate (PET), or acrylonitrile butadiene styrene (ABS). The sign clip 1100 may be formed from 3-D printing, injection molding, compression molding, blow molding, or other manufacturing processes.

An interior surface 1114 of the first side wall 1108, an interior surface 1116 of the second side wall 1110, and the partitions 1112 may define three slots 1118 corresponding to the gap between the first side wall 1108 and the second side wall 1110. The slots 1118 are configured to temporarily receive and fix a portion of a sign relative to the sign clip 1100. Conventional signs used in advertising have a thickness of about 4.5 mm, though some signs may have thicknesses up to about 10 mm. The slots 1118 may have a width, defined by the distance between the first side wall 1108 and the second side wall 1110, within a range of from about 2 mm to about 10 mm. In some embodiments, the width varies (e.g., tapers) along the full depth of each slot 1118. For example, a shallow region of the slots 1118 adjacent outer edges of the side walls 1108 and 1110, distal to the partition 1112, may be within a range of from about 5 mm to about 9 mm. The width may then decrease through a narrow intermediate region to within a range of from about 2 mm to about 3 mm, and the width may increase toward a deepest region of the slots 1118, proximal to the partition 1112, to within a range of from about 4 mm to about 10 mm. In some embodiments the slots 1118 may have a width of about 9 mm distal to the partition 1112, a width of about 2.5 mm at the intermediate region, and a width of about 4.5 mm at the deepest region proximal to the partition 1112. The narrow intermediate region of the slots 1118 may compress a semi-rigid corrugated sign as the sign is inserted, and the sign may then elastically expand within the wider, deeper portion of the slots 1118, providing frictional retention without damage to the sign.

Conventional signs used in advertising have a border around the edge of the signs with no advertisements. The slots 1118 may have a depth, defined by a direction substantially perpendicular to the width of the slots 1118, of about 10 mm. The depth of the slots 1118 may facilitate the slots receiving a portion of the signs corresponding to the border of the sign. The sign clip 1100 may be configured to blend into the border of the sign and be less noticeable when attached to the signs, thereby facilitating the advertising on the sign to retain attention of a viewer. The length of the slots 1118, defined by a direction substantially perpendicular to both the width and the depth of the slots 1118, may be about 60 mm. In some embodiments, the length of the slots 1118 may be within a range from about 10 mm to about 80 mm.

Referring to FIG. 21, the direction of the width, the depth, and the length of the slots 1118 may vary relative to a reference plane, such as an X-Y plane or other reference plane in any X-Y, X-Z, Y-Z plane or some combination thereof. For example, the length of the slots 1118 may extend substantially in the X direction for a portion of each of the slots 1118 and may shift to extend substantially in the Y direction for another portion of each of the slots 1118. The direction of the width, the depth, and the length of the slots 1118 remain constant relative to each other even when shifting relative to the X-Y plane, or another reference plane or reference grid, which may include a third direction, Z. Varying the direction of the width, the depth, and the length of the slots 1118 relative to a reference plane facilitates connection of the sign clip 1100 to a corner of a sign having a substantially 90-degree angle.

Each of the interior surfaces 1114 and 1116 may include one or more teeth 1124. For example, each of the interior surfaces 1114 and 1116 may include one, two, three, four, five, or more teeth 1124. The teeth 1124 are configured to have a height, defined by the distance from the interior surface 1114 or 1116, of about 3.0 mm. In some embodiments, the teeth 1124 may have a height within a range from about 0.65 mm to about 3.0 mm. The distance between the teeth 1124 on the interior surface 1114 and the teeth 1124 on the interior surface 1116 may be in a range of from about 2 mm to about 4 mm. In some embodiments the distance between the teeth 1124 on the interior surface 1114 and the teeth 1124 on the interior surface 1116 may be about 2.75 mm. In some embodiments, the teeth 1124 may be configured to have a hemispherical shape with a diameter of about 1.5 mm. In some embodiments the teeth 1124 may have a diameter within a range of from about 0.5 mm to about 3 mm. The teeth 1124 are configured to facilitate connection to the sign such that the sign will not slip out of the slots 1118 unintentionally and will also not damage the sign when the sign is removed from the slots 1118 intentionally. In some embodiments, teeth 1124 are located at a depth of about 2.25 mm into the slots 1118 from an outer edge of the first side wall 1108 and second side wall 1110. In some embodiments the teeth 1124 may be located at the narrowest portion of the slots 1118.

The junction 1106 may include at least two corners 1122 defining at least two angles (α and β). Angle α is defined between the first side wall 1108 of the third portion 1105 and the second side wall 1110 of the first portion 1102. Angle β is defined between the second side wall 1110 of the third portion 1105 and the second side wall 1110 of the second portion 1104. The angles (α and/or β) may be within a range from about 15 degrees to about 175 degrees. In some embodiments, the angles (α and/or β) are within a range from about 45 degrees to about 145 degrees or within a range from about 75 degrees to about 115 degrees. In some embodiments, the angles (α and/or β) are about 90 degrees. In some embodiments, the angles (α and β) add up to 180 degrees.

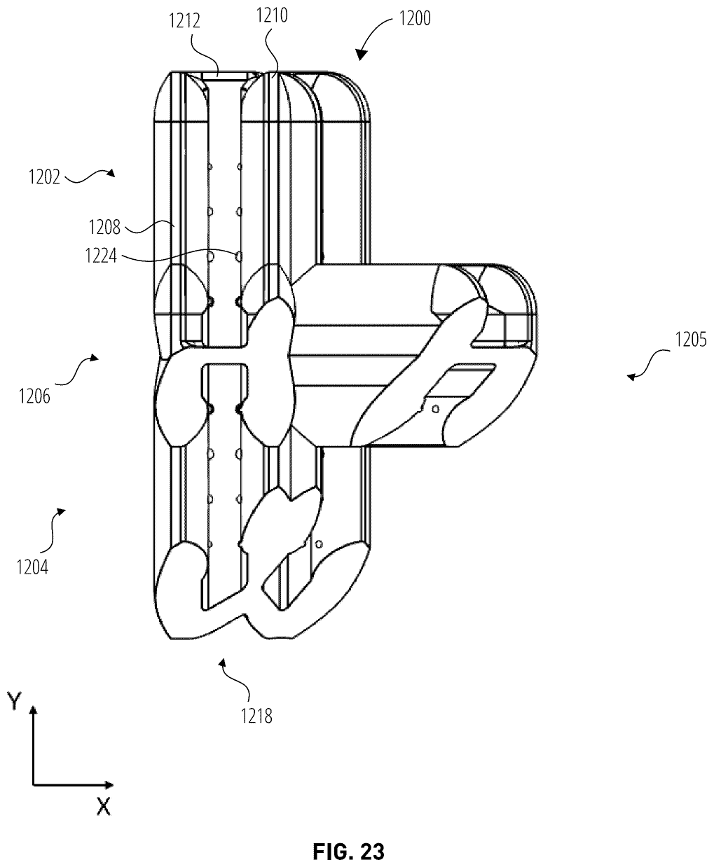

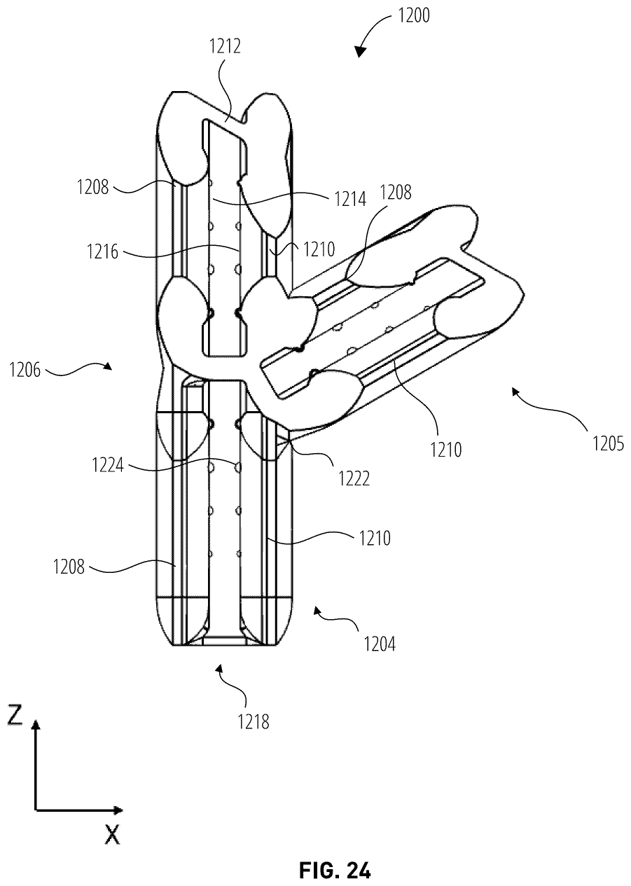

FIGS. 23 and 24 show an embodiment of a sign clip 1200. The sign clip 1200 may include a first portion 1202, a second portion 1204, and a third portion 1205 connected to one another at a junction 1206. Each of the first portion 1202, the second portion 1204, and the third portion 1205 may include a free end that terminates in a planar face cut at an oblique angle to a longitudinal axis of each of the portions 1202, 1204, and 1205. Each of the first portion 1202, the second portion 1204, and the third portion 1205 includes a first side wall 1208 and a second side wall 1210. The first side wall 1208 is connected to the second side wall 1210 by one or more partitions 1212. The first side wall 1208 and the second side wall 1210 are positioned to maintain a substantially constant gap therebetween. In some embodiments, the first side wall 1208 and the second side wall 1210 may not be positioned to have a substantially constant gap therebetween. The first side wall 1208, the second side wall 1210, and the partitions 1212 may have a thickness within a range from about 0.5 mm to about 10 mm. In some embodiments, the thickness of the first side wall 1208, the second side wall 1210, and the partitions 1212 may be within a range from about 4 mm to about 5 mm, or about 4.5 mm. The first side wall 1208, the second side wall 1210, and the partitions 1212 may be formed of a plastic material such as a polylactic acid (PLA), polyethylene terephthalate (PET), or acrylonitrile butadiene styrene (ABS). The sign clip 1200 may be formed from 3-D printing, injection molding, compression molding, blow molding, or other manufacturing processes.

An interior surface 1214 of the first side wall 1208, an interior surface 1216 of the second side wall 1210, and the partitions 1212 may define six slots 1218 corresponding to the gap between the first side wall 1208 and the second side wall 1210. The slots 1218 are configured to temporarily receive and fix a portion of a sign relative to the sign clip 1200. Conventional signs used in advertising have a thickness of about 4.5 mm, though some signs may have thicknesses up to about 10 mm. The slots 1218 may have a width, defined by the distance between the first side wall 1208 and the second side wall 1210, within a range of from about 2 mm to about 10 mm. In some embodiments, the width varies (e.g., tapers) along the full depth of each slot 1218. For example, a shallow region of the slots 1218 adjacent outer edges of the side walls 1208 and 1210, distal to the partition 1212, may be within a range of from about 5 mm to about 9 mm. The width may then decrease through a narrow intermediate region to within a range of from about 2 mm to about 3 mm, and the width may increase toward a deepest region of the slots 1218, proximal to the partition 1212, to within a range of from about 4 mm to about 10 mm. In some embodiments the slots 1218 may have a width of about 9 mm distal to the partition 1212, a width of about 2.5 mm at the intermediate region, and a width of about 4.5 mm at the deepest region proximal to the partition 1212. The narrow intermediate region of the slots 1218 may compress a semi-rigid corrugated sign as the sign is inserted, and the sign may then elastically expand within the wider, deeper portion of the slots 1218, providing frictional retention without damage to the sign.

Conventional signs used in advertising have a border around the edge of the signs with no advertisements. The slots 1218 may have a depth, defined by a direction substantially perpendicular to the width of the slots 1218, of about 10 mm. The depth of the slots 1218 may facilitate the slots receiving a portion of the signs corresponding to the border of the sign. The sign clip 1200 may be configured to blend into the border of the sign and be less noticeable when attached to the signs, thereby facilitating the advertising on the sign to retain attention of a viewer. The length of the slots 1218, defined by a direction substantially perpendicular to both the width and the depth of the slots 1218, may be about 60 mm. In some embodiments, the length of the slots 1218 may be within a range from about 10 mm to about 80 mm.

Referring to FIG. 23, the direction of the width, the depth, and the length of the slots 1218 may vary relative to a reference plane, such as an X-Y plane or other reference plane in any X-Y, X-Z, Y-Z plane or some combination thereof. For example, the length of the slots 1218 may extend substantially in the X direction for a portion of each of the slots 1218 and may shift to extend substantially in the Y direction for another portion of each of the slots 1218. The direction of the width, the depth, and the length of the slots 1218 remain constant relative to each other even when shifting relative to the X-Y plane, or another reference plane or reference grid, which may include a third direction, Z. Varying the direction of the width, the depth, and the length of the slots 1218 relative to a reference plane facilitates connection of the sign clip 1200 to a corner of a sign having a substantially 90-degree angle.

Each of the interior surfaces 1214 and 1216 may include one or more teeth 1224. For example, each of the interior surfaces 1214 and 1216 may include one, two, three, four, five, or more teeth 1224. The teeth 1224 are configured to have a height, defined by the distance from the interior surface 1214 or 1216, of about 3.0 mm. In some embodiments, the teeth 1224 may have a height within a range from about 0.65 mm to about 3.0 mm. The distance between the teeth 1224 on the interior surface 1214 and the teeth 1224 on the interior surface 1216 may be in a range of from about 2 mm to about 4 mm. In some embodiments the distance between the teeth 1224 on the interior surface 1214 and the teeth 1224 on the interior surface 1216 may be about 2.75 mm. In some embodiments, the teeth 1224 may be configured to have a hemispherical shape with a diameter of about 1.5 mm. In some embodiments the teeth 1224 may have a diameter within a range of from about 0.5 mm to about 3 mm. The teeth 1224 are configured to facilitate connection to the sign such that the sign will not slip out of the slots 1218 unintentionally and will also not damage the sign when the sign is removed from the slots 1218 intentionally. In some embodiments, teeth 1224 are located at a depth of about 2.25 mm into the slots 1218 from an outer edge of the first side wall 1208 and second side wall 1210. In some embodiments the teeth 1224 may be located at the narrowest portion of the slots 1218.

The junction 1206 may include at least two corners 1222 defining at least two angles (α and β). Angle α is defined between the first side wall 1208 of the third portion 1205 and the second side wall 1210 of the first portion 1202. Angle β is defined between the second side wall 1210 of the third portion 1205 and the second side wall 1210 of the second portion 1204. The angles (α and/or β) may be within a range from about 15 degrees to about 175 degrees. In some embodiments, the angles (α and/or β) are within a range from about 45 degrees to about 145 degrees or within a range from about 75 degrees to about 115 degrees. In some embodiments, the angles (α and/or β) are about 90 degrees. In some embodiments, the angles (α and β) add up to 180 degrees.

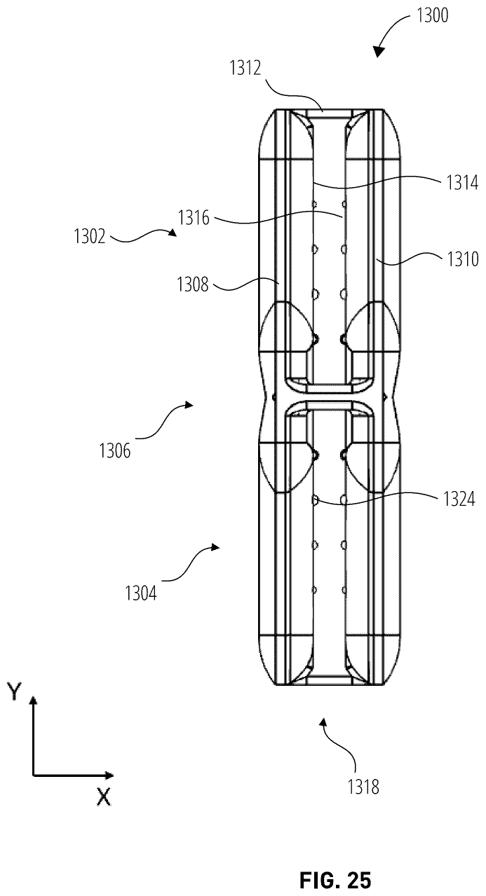

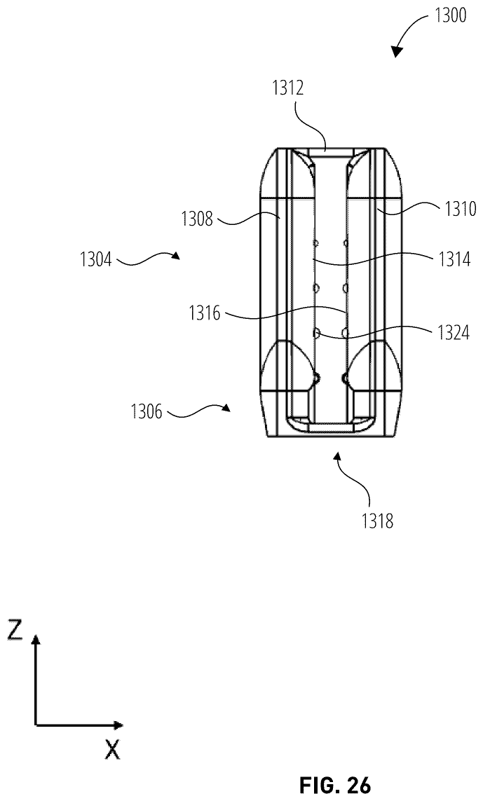

FIGS. 25 and 26 show an embodiment of a sign clip 1300. The sign clip 1300 may include a first portion 1302 and a second portion 1304 connected to the first portion 1302 at a junction 1306. Each of the first portion 1302 and the second portion 1304 includes a first side wall 1308 and a second side wall 1310. The first side wall 1308 is connected to the second side wall 1310 by one or more partitions 1312. The first side wall 1308 and the second side wall 1310 are positioned to maintain a substantially constant gap therebetween. In some embodiments, the first side wall 1308 and the second side wall 1310 may not be positioned to have a substantially constant gap therebetween. The first side wall 1308, the second side wall 1310, and the partitions 1312 may have a thickness within a range from about 0.5 mm to about 10 mm. In some embodiments, the thickness of the first side wall 1308, the second side wall 1310, and the partitions 1312 may be within a range from about 4 mm to about 5 mm, or about 4.5 mm. The first side wall 1308, the second side wall 1310, and the partitions 1312 may be formed of a plastic material such as a polylactic acid (PLA), polyethylene terephthalate (PET), or acrylonitrile butadiene styrene (ABS). The sign clip 1300 may be formed from 3D printing, injection molding, compression molding, blow molding, or other manufacturing processes.

An interior surface 1314 of the first side wall 1308, an interior surface 1316 of the second side wall 1310, and the partitions 1312 may define two slots 1318 corresponding to the gap between the first side wall 1308 and the second side wall 1310. The slots 1318 are configured to temporarily receive and fix a portion of a sign relative to the sign clip 1300. Conventional signs used in advertising have a thickness of about 4.5 mm, though some signs may have thicknesses up to about 10 mm. The slots 1318 may have a width, defined by the distance between the first side wall 1308 and the second side wall 1310, within a range of from about 2 mm to about 10 mm. In some embodiments, the width varies (e.g., tapers) along the full depth of each slot 1318. For example, a shallow region of the slots 1318 adjacent outer edges of the side walls 1308 and 1310, distal to the partition 1312, may be within a range of from about 5 mm to about 9 mm. The width may then decrease through a narrow intermediate region to within a range of from about 2 mm to about 3 mm, and the width may increase toward a deepest region of the slots 1318, proximal to the partition 1312, to within a range of from about 4 mm to about 10 mm. In some embodiments the slots 1318 may have a width of about 9 mm distal to the partition 1312, a width of about 2.5 mm at the intermediate region and a width of about 4.5 mm at the deepest region proximal to the partition 1312. The narrow intermediate region of the slots 1318 may compress a semi-rigid corrugated sign as the sign is inserted, and the sign may then elastically expand within the wider, deeper portion of the slots 1318, providing frictional retention without damage to the sign.

Conventional signs used in advertising have a border around the edge of the signs with no advertisements. The slots 1318 may have a depth, defined by a direction substantially perpendicular to the width of the slots 1318, of about 10 mm. The depth of the slots 1318 may facilitate the slots receiving a portion of the signs corresponding to the border of the sign. The sign clip 1300 may be configured to blend into the border of the sign and be less noticeable when attached to the signs, thereby facilitating the advertising on the sign to retain attention of a viewer. The length of the slots 1318, defined by a direction substantially perpendicular to both the width and the depth of the slots 1318, may be about 60 mm. In some embodiments, the length of the slots 1318 may be within a range from about 10 mm to about 80 mm.

Referring to FIG. 25, the direction of the width, the depth, and the length of the slots 1318 may vary relative to a reference plane, such as an X-Y plane or other reference plane in any X-Y, X-Z, Y-Z plane or some combination thereof. For example, the length of the slots 1318 may extend substantially in the X direction for a portion of each of the slots 1318 and may shift to extend substantially in the Y direction for another portion of each of the slots 1318. The direction of the width, the depth, and the length of the slots 1318 remain constant relative to each other even when shifting relative to the X-Y plane, or another reference plane or reference grid, which may include a third direction, Z. Varying the direction of the width, the depth, and the length of the slots 1318 relative to a reference plane facilitates connection of the sign clip 1300 to a corner of a sign having a substantially 90-degree angle.

Each of the interior surfaces 1314 and 1316 may include one or more teeth 1324. For example, each of the interior surfaces 1314 and 1316 may include one, two, three, four, five, or more teeth 1324. The teeth 1324 are configured to have a height, defined by the distance from the interior surface 1314 or 1316, of about 3.0 mm. In some embodiments, the teeth 1324 may have a height within a range from about 0.65 mm to about 3.0 mm. The distance between the teeth 1324 on the interior surface 1314 and the teeth 1324 on the interior surface 1316 may be in a range of from about 2 mm to about 4 mm. In some embodiments the distance between the teeth 1324 on the interior surface 1314 and the teeth 1324 on the interior surface 1316 may be about 2.75 mm. In some embodiments, the teeth 1324 may be configured to have a hemispherical shape with a diameter of about 1.5 mm. In some embodiments the teeth 1324 may have a diameter within a range of from about 0.5 mm to about 3 mm. The teeth 1324 are configured to facilitate connection to the sign such that the sign will not slip out of the slots 1318 unintentionally and will also not damage the sign when the sign is removed from the slots 1318 intentionally. In some embodiments, teeth 1324 are located at a depth of about 2.25 mm into the slots 1318 from an outer edge of the first side wall 1308 and second side wall 1310. In some embodiments the teeth 1324 may be located at the narrowest portion of the slots 1318.

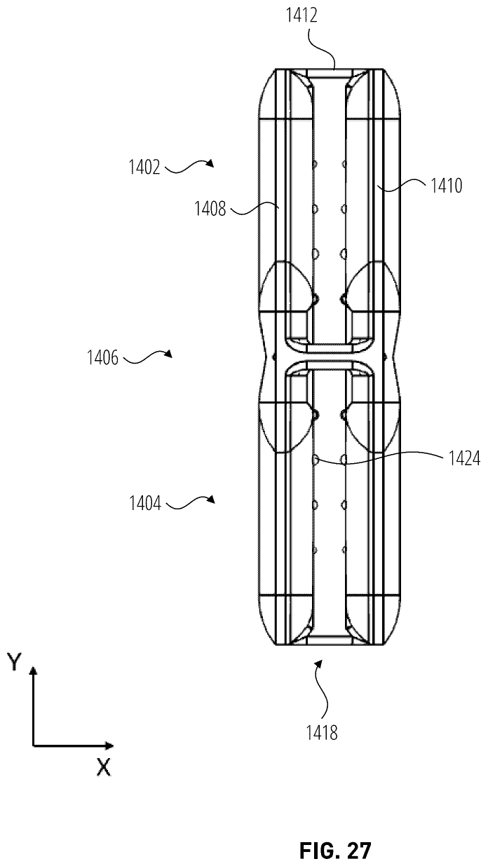

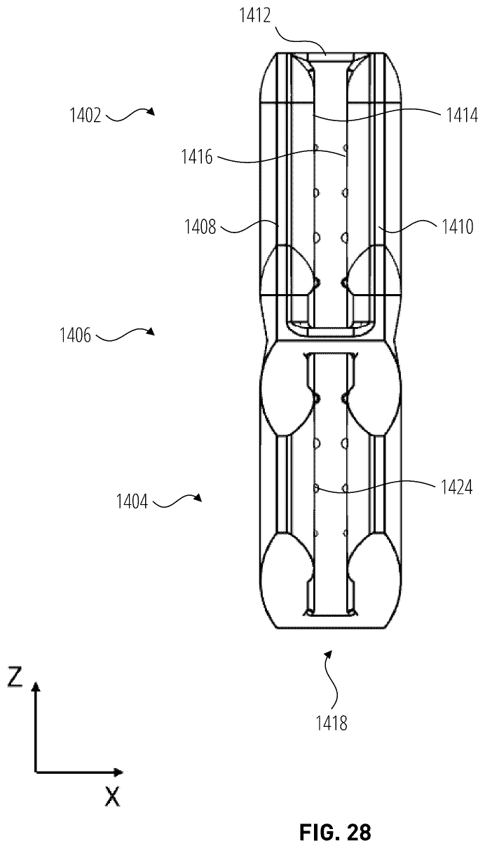

FIGS. 27 and 28 show an embodiment of a sign clip 1400. The sign clip 1400 may include a first portion 1402 and a second portion 1404 connected to the first portion 1402 at a junction 1406. The second portion 1404 may include free ends that terminate in a planar face cut at an oblique angle to a longitudinal axis of the second portion 1404. Each of the first portion 1402 and the second portion 1404 includes a first side wall 1408 and a second side wall 1410. The first side wall 1408 is connected to the second side wall 1410 by one or more partitions 1412. The first side wall 1408 and the second side wall 1410 are positioned to maintain a substantially constant gap therebetween. In some embodiments, the first side wall 1408 and the second side wall 1410 may not be positioned to have a substantially constant gap therebetween. The first side wall 1408, the second side wall 1410, and the partitions 1412 may have a thickness within a range from about 0.5 mm to about 10 mm. In some embodiments, the thickness of the first side wall 1408, the second side wall 1410, and the partitions 1412 may be within a range from about 4 mm to about 5 mm, or about 4.5 mm. The first side wall 1408, the second side wall 1410, and the partitions 1412 may be formed of a plastic material such as a polylactic acid (PLA), polyethylene terephthalate (PET), or acrylonitrile butadiene styrene (ABS). The sign clip 1400 may be formed from 3D printing, injection molding, compression molding, blow molding, or other manufacturing processes.

An interior surface 1414 of the first side wall 1408, an interior surface 1416 of the second side wall 1410, and the partitions 1412 may define four slots 1418 corresponding to the gap between the first side wall 1408 and the second side wall 1410. The slots 1418 are configured to temporarily receive and fix a portion of a sign relative to the sign clip 1400. Conventional signs used in advertising have a thickness of about 4.5 mm, though some signs may have thicknesses up to about 10 mm. The slots 1418 may have a width, defined by the distance between the first side wall 1408 and the second side wall 1410, within a range of from about 2 mm to about 10 mm. In some embodiments, the width varies (e.g., tapers) along the full depth of each slot 1418. For example, a shallow region of the slots 1418 adjacent outer edges of the side walls 1408 and 1410, distal to the partition 1412, may be within a range of from about 5 mm to about 9 mm. The width may then decrease through a narrow intermediate region to within a range of from about 2 mm to about 3 mm, and the width may increase toward a deepest region of the slots 1418, proximal to the partition 1412, to within a range of from about 4 mm to about 10 mm. In some embodiments the slots 1418 may have a width of about 9 mm distal to the partition 1412, a width of about 2.5 mm at the intermediate region and a width of about 4.5 mm at the deepest region proximal to the partition 1412. The narrow intermediate region of the slots 1418 may compress a semi-rigid corrugated sign as the sign is inserted, and the sign may then elastically expand within the wider, deeper portion of the slots 1418, providing frictional retention without damage to the sign.

Conventional signs used in advertising have a border around the edge of the signs with no advertisements. The slots 1418 may have a depth, defined by a direction substantially perpendicular to the width of the slots 1418, of about 10 mm. The depth of the slots 1418 may facilitate the slots receiving a portion of the signs corresponding to the border of the sign. The sign clip 1400 may be configured to blend into the border of the sign and be less noticeable when attached to the signs, thereby facilitating the advertising on the sign to retain attention of a viewer. The length of the slots 1418, defined by a direction substantially perpendicular to both the width and the depth of the slots 1418, may be about 60 mm. In some embodiments, the length of the slots 1418 may be within a range from about 10 mm to about 80 mm.

Referring to FIG. 27, the direction of the width, the depth, and the length of the slots 1418 may vary relative to a reference plane, such as an X-Y plane or other reference plane in any X-Y, X-Z, Y-Z plane or some combination thereof. For example, the length of the slots 1418 may extend substantially in the X direction for a portion of each of the slots 1418 and may shift to extend substantially in the Y direction for another portion of each of the slots 1418. The direction of the width, the depth, and the length of the slots 1418 remain constant relative to each other even when shifting relative to the X-Y plane, or another reference plane or reference grid, which may include a third direction, Z. Varying the direction of the width, the depth, and the length of the slots 1418 relative to a reference plane facilitates connection of the sign clip 1400 to a corner of a sign having a substantially 90-degree angle.

Each of the interior surfaces 1414 and 1416 may include one or more teeth 1424. For example, each of the interior surfaces 1414 and 1416 may include one, two, three, four, five, or more teeth 1424. The teeth 1424 are configured to have a height, defined by the distance from the interior surface 1414 or 1416, of about 3.0 mm. In some embodiments, the teeth 1424 may have a height within a range from about 0.65 mm to about 3.0 mm. The distance between the teeth 1424 on the interior surface 1414 and the teeth 1424 on the interior surface 1416 may be in a range of from about 2 mm to about 4 mm. In some embodiments the distance between the teeth 1424 on the interior surface 1414 and the teeth 1424 on the interior surface 1416 may be about 2.75 mm. In some embodiments, the teeth 1424 may be configured to have a hemispherical shape with a diameter of about 1.5 mm. In some embodiments the teeth 1424 may have a diameter within a range of from about 0.5 mm to about 3 mm. The teeth 1424 are configured to facilitate connection to the sign such that the sign will not slip out of the slots 1418 unintentionally and will also not damage the sign when the sign is removed from the slots 1418 intentionally. In some embodiments, teeth 1424 are located at a depth of about 2.25 mm into the slots 1418 from an outer edge of the first side wall 1408 and second side wall 1410. In some embodiments the teeth 1424 may be located at the narrowest portion of the slots 1418.

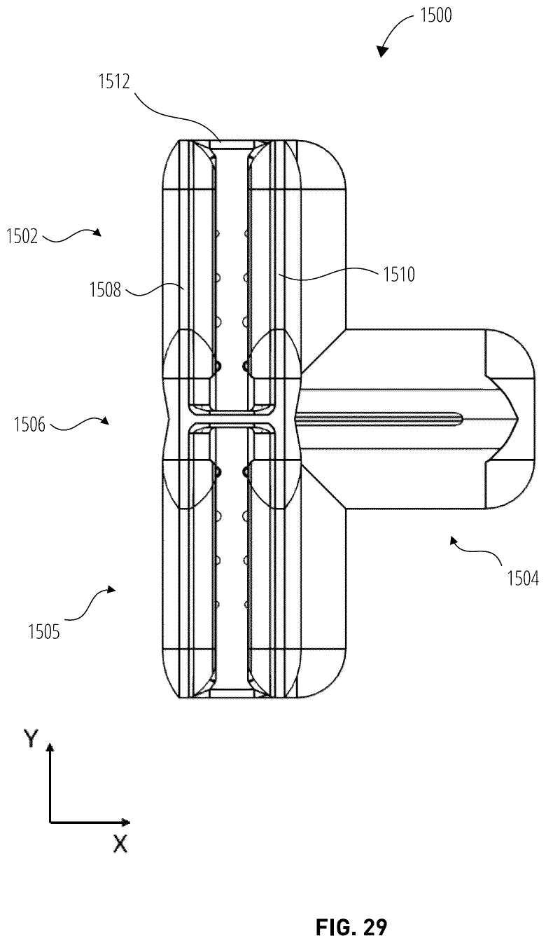

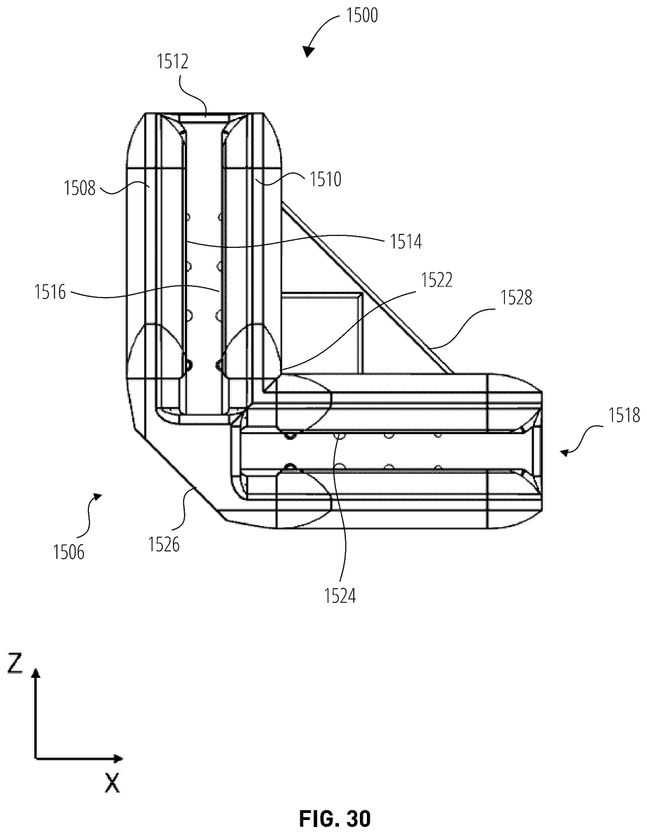

FIGS. 29 and 30 show an embodiment of a sign clip 1500. The sign clip 1500 may include a first portion 1502 and a second portion 1504 connected to the first portion 1502 at a junction 1506. Each of the first portion 1502 and the second portion 1504 includes a first side wall 1508 and a second side wall 1510. The first side wall 1508 is connected to the second side wall 1510 by one or more partitions 1512. The first side wall 1508 and the second side wall 1510 are positioned to maintain a substantially constant gap therebetween. In some embodiments, the first side wall 1508 and the second side wall 1510 may not be positioned to have a substantially constant gap therebetween. The first side wall 1508, the second side wall 1510, and the partitions 1512 may have a thickness within a range from about 0.5 mm to about 10 mm. In some embodiments, the thickness of the first side wall 1508, the second side wall 1510, and the partitions 1512 may be within a range from about 4 mm to about 5 mm, or about 4.5 mm. The first side wall 1508, the second side wall 1510, and the partitions 1512 may be formed of a plastic material such as a polylactic acid (PLA), polyethylene terephthalate (PET), or acrylonitrile butadiene styrene (ABS). The sign clip 1500 may be formed from 3D printing, injection molding, compression molding, blow molding, or other manufacturing processes.

An interior surface 1514 of the first side wall 1508, an interior surface 1516 of the second side wall 1510, and the partitions 1512 may define four slots 1518 corresponding to the gap between the first side wall 1508 and the second side wall 1510. The slots 1518 are configured to temporarily receive and fix a portion of a sign relative to the sign clip 1500. Conventional signs used in advertising have a thickness of about 4.5 mm, though some signs may have thicknesses up to about 10 mm. The slots 1518 may have a width, defined by the distance between the first side wall 1508 and the second side wall 1510, within a range of from about 2 mm to about 10 mm. In some embodiments, the width varies (e.g., tapers) along the full depth of each slot 1518. For example, a shallow region of the slots 1518 adjacent outer edges of the side walls 1508 and 1510, distal to the partition 1512, may be within a range of from about 5 mm to about 9 mm. The width may then decrease through a narrow intermediate region to within a range of from about 2 mm to about 3 mm, and the width may increase toward a deepest region of the slots 1518, proximal to the partition 1512, to within a range of from about 4 mm to about 10 mm. In some embodiments the slots 1518 may have a width of about 9 mm distal to the partition 1512, a width of about 2.5 mm at the intermediate region and a width of about 4.5 mm at the deepest region proximal to the partition 1512. The narrow intermediate region of the slots 1518 may compress a semi-rigid corrugated sign as the sign is inserted, and the sign may then elastically expand within the wider, deeper portion of the slots 1518, providing frictional retention without damage to the sign.

The slots 1518 may have a depth, defined by a direction substantially perpendicular to the width of the slots 1518, of about 10 mm. The depth of the slots 1518 may facilitate the slots receiving a portion of the signs corresponding to the border of the sign. The sign clip 1500 may be configured to blend into the border of the sign and be less noticeable when attached to the signs, thereby facilitating the advertising on the sign to retain attention of a viewer. The length of the slots 1518, defined by a direction substantially perpendicular to both the width and the depth of the slots 1518, may be about 65 mm. In some embodiments, the length of the slots 1518 may be within a range from about 10 mm to about 80 mm.

Referring to FIG. 29, the direction of the width, the depth, and the length of the slots 1518 may vary relative to a reference plane, such as an X-Y plane or other reference plane in any X-Y, X-Z, Y-Z plane or some combination thereof. For example, the length of the slots 1518 may extend substantially in the X direction for a portion of each of the slots 1518 and may shift to extend substantially in the Y direction for another portion of each of the slots 1518. The direction of the width, the depth, and the length of the slots 1518 remain constant relative to each other even when shifting relative to the X-Y plane, or another reference plane or reference grid, which may include a third direction, Z. Varying the direction of the width, the depth, and the length of the slots 1518 relative to a reference plane facilitates connection of the sign clip 1500 to a corner of a sign having a substantially 90 degree angle.

Each of the interior surfaces 1514 and 1516 may include one or more teeth 1524. For example, each of the interior surfaces 1514 and 1516 may include one, two, three, four, five, or more teeth 1524. The teeth 1524 are configured to have a height, defined by the distance from the interior surface 1514 or 1516, of about 3.0 mm. In some embodiments, the teeth 1524 may have a height within a range from about 0.65 mm to about 3.0 mm. The distance between the teeth 1524 on the interior surface 1514 and the teeth 1524 on the interior surface 1516 may be in a range of from about 2 mm to about 4 mm. In some embodiments the distance between the teeth 1524 on the interior surface 1514 and the teeth 1524 on the interior surface 1516 may be about 2.75 mm. In some embodiments, the teeth 1524 may be configured to have a hemispherical shape with a diameter of about 1.5 mm. In some embodiments the teeth 1524 may have a diameter within a range of from about 0.5 mm to about 3 mm. The teeth 1524 are configured to facilitate connection to the sign such that the sign will not slip out of the slots 1518 unintentionally and will also not damage the sign when the sign is removed from the slots 1518 intentionally. In some embodiments, teeth 1524 are located at a depth of about 2.25 mm into the slots 1518 from an outer edge of the first side wall 1508 and second side wall 1510. In some embodiments the teeth 1524 may be located at the narrowest portion of the slots 1518.

The junction 1506 may include a corner 1522 defining an angle (α) between the first side wall 1508 of the first portion 1502 and the second portion 1504. The angle (α) may be within a range from about 15 degrees to about 175 degrees. In some embodiments, the angle (α) is within a range from about 45 degrees to about 145 degrees or within a range from about 75 degrees to about 115 degrees. In some embodiments, the angle (α) is about 60 degrees, about 90 degrees, or about 180 degrees. The junction 1506 may also include a third side wall 1526 connecting the second side wall 1510 of the first portion 1502 and the second portion 1504. In some embodiments, the corner 1522 may be adjacent to or connected to the third side wall 1526. The third side wall 1526 may also partially define each of the slots 1518.

In some embodiments the sign clip 1500 may include a brace 1528 disposed between the first portion 1502 and the second portion 1504. The brace 1528 may be integral with the first side wall 1508 of the first portion 1502 and the first side wall 1510 of the second portion 1504. The brace 1528 may help maintain the angular relationship of the first portion 1502 to the second portion 1504 during manufacture, handling, and use. In some embodiments the brace 1528 may be removed after manufacture, and in some embodiments the sign clip 1500 may not include a brace 1528.

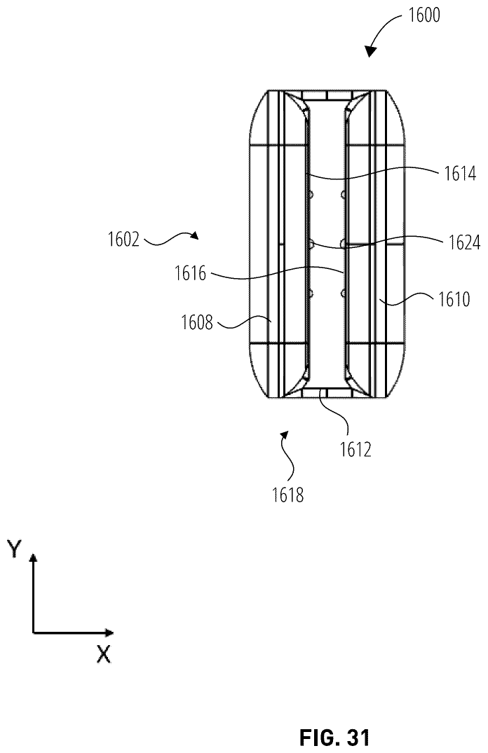

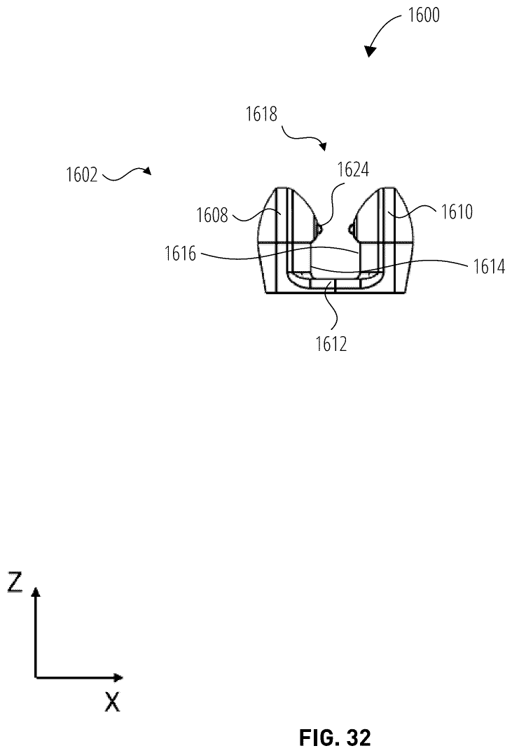

FIGS. 31 and 32 show an embodiment of a sign clip 1600. The sign clip 1600 may include a first portion 1602. The first portion 1602 includes a first side wall 1608 and a second side wall 1610. The first side wall 1608 is connected to the second side wall 1610 by one or more partitions 1612. The first side wall 1608 and the second side wall 1610 are positioned to maintain a substantially constant gap therebetween. In some embodiments, the first side wall 1608 and the second side wall 1610 may not be positioned to have a substantially constant gap therebetween. The first side wall 1608, the second side wall 1610, and the partitions 1612 may have a thickness within a range from about 0.5 mm to about 10 mm. In some embodiments, the thickness of the first side wall 1608, the second side wall 1610, and the partitions 1612 may be within a range from about 4 mm to about 5 mm, or about 4.5 mm. The first side wall 1608, the second side wall 1610, and the partitions 1612 may be formed of a plastic material such as a polylactic acid (PLA), polyethylene terephthalate (PET), or acrylonitrile butadiene styrene (ABS). The sign clip 1600 may be formed from 3D printing, injection molding, compression molding, blow molding, or other manufacturing processes.

An interior surface 1614 of the first side wall 1608, an interior surface 1616 of the second side wall 1610, and the partitions 1612 may define one slot 1618 corresponding to the gap between the first side wall 1608 and the second side wall 1610. The slot 1618 is configured to temporarily receive and fix a portion of a sign relative to the sign clip 1600. Conventional signs used in advertising have a thickness of about 4.5 mm, though some signs may have thicknesses up to about 10 mm. The slots 1618 may have a width, defined by the distance between the first side wall 1608 and the second side wall 1610, within a range of from about 2 mm to about 10 mm. In some embodiments, the width varies (e.g., tapers) along the full depth of each slot 1618. For example, a shallow region of the slot 1618 adjacent outer edges of the side walls 1608 and 1610, distal to the partition 1612, may be within a range of from about 5 mm to about 9 mm. The width may then decrease through a narrow intermediate region to within a range of from about 2 mm to about 3 mm, and the width may increase toward a deepest region of the slots 1618, proximal to the partition 1612, to within a range of from about 4 mm to about 10 mm. In some embodiments the slots 1618 may have a width of about 9 mm distal to the partition 1612, a width of about 2.5 mm at the intermediate region and a width of about 4.5 mm at the deepest region proximal to the partition 1612. The narrow intermediate region of the slots 1618 may compress a semi-rigid sign as the sign is inserted, and the sign may then elastically expand within the wider, deeper portion of the slots 1618, providing frictional retention without damage to the sign.

Conventional signs used in advertising have a border around the edge of the signs with no advertisements. The slots 1618 may have a depth, defined by a direction substantially perpendicular to the width of the slots 1618, of about 10 mm. The depth of the slots 1618 may facilitate the slots receiving a portion of the signs corresponding to the border of the sign. The sign clip 1600 may be configured to blend into the border of the sign and be less noticeable when attached to the signs, thereby facilitating the advertising on the sign to retain attention of a viewer. The length of the slot 1618, defined by a direction substantially perpendicular to both the width and the depth of the slot 1618, may be about 60 mm. In some embodiments, the length of the slot 1618 may be within a range from about 10 mm to about 80 mm. The direction of the width, the depth, and the length of the slot 1618 may remain constant relative to a reference plane, such as an X-Y plane or other reference plane in any X-Y, X-Z, Y-Z plane or some combination thereof.

Each of the interior surfaces 1614 and 1616 may include one or more teeth 1624. For example, each of the interior surfaces 1614 and 1616 may include one, two, three, four, five, or more teeth 1624. The teeth 1624 are configured to have a height, defined by the distance from the interior surface 1614 or 1616, of about 3.0 mm. In some embodiments, the teeth 1624 may have a height within a range from about 0.65 mm to about 3.0 mm. The distance between the teeth 1624 on the interior surface 1614 and the teeth 1624 on the interior surface 1616 may be in a range of from about 2 mm to about 4 mm. In some embodiments the distance between the teeth 1624 on the interior surface 1614 and the teeth 1624 on the interior surface 1616 may be about 2.75 mm. In some embodiments, the teeth 1624 may be configured to have a hemispherical shape with a diameter of about 1.5 mm. In some embodiments the teeth 1624 may have a diameter within a range of from about 0.5 mm to about 3 mm. The teeth 1624 are configured to facilitate connection to the sign such that the sign will not slip out of the slot 1618 unintentionally and will also not damage the sign when the sign is removed from the slot 1618 intentionally. In some embodiments, teeth 1624 are located at a depth of about 2.25 mm into the slot 1618 from an outer edge of the first side wall 1608 and second side wall 1610. In some embodiments the teeth 1624 may be located at the narrowest portion of the slot 1618.

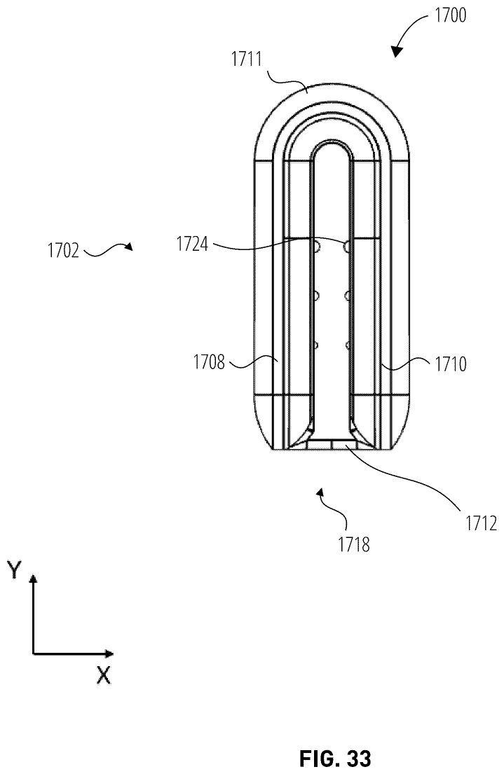

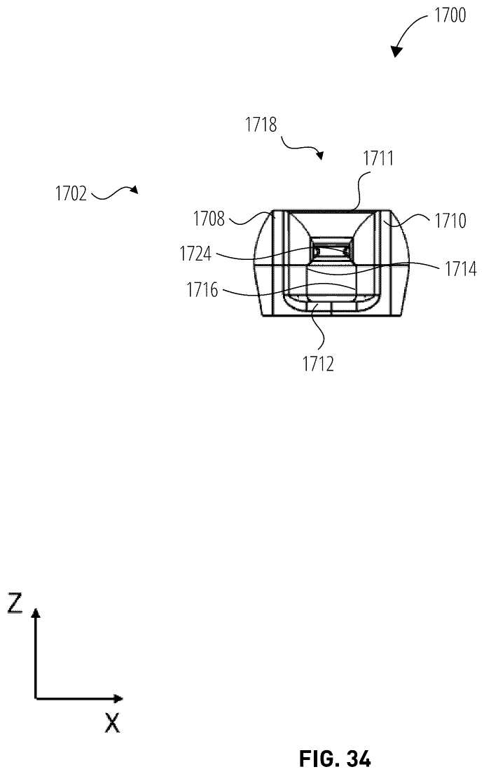

FIGS. 33 and 34 show an embodiment of a sign clip 1700. The sign clip 1700 may include a first portion 1702. The first portion 1702 includes a first side wall 1708 and a second side wall 1710. The first side wall 1708 is connected to the second side wall 1710 by one or more partitions 1712. The sign clip 1700 may also include a third side wall 1711 connecting the first side wall 1708 to the second side wall 1710. The first side wall 1708 and the second side wall 1710 are positioned to maintain a substantially constant gap therebetween. In some embodiments, the first side wall 1708 and the second side wall 1710 may not be positioned to have a substantially constant gap therebetween. The first side wall 1708, the second side wall 1710, and the partitions 1712 may have a thickness within a range from about 0.5 mm to about 10 mm. In some embodiments, the thickness of the first side wall 1708, the second side wall 1710, and the partitions 1712 may be within a range from about 4 mm to about 5 mm, or about 4.5 mm. The first side wall 1708, the second side wall 1710, and the partitions 1712 may be formed of a plastic material such as a polylactic acid (PLA), polyethylene terephthalate (PET), or acrylonitrile butadiene styrene (ABS). The sign clip 1700 may be formed from 3D printing, injection molding, compression molding, blow molding, or other manufacturing processes.

An interior surface 1714 of the first side wall 1708, an interior surface 1716 of the second side wall 1710, and the partitions 1712 may define one slot 1718 corresponding to the gap between the first side wall 1708 and the second side wall 1710. The third side wall 1711 may also partially define the slot 1718. The slot 1718 is configured to temporarily receive and fix a portion of a sign relative to the sign clip 1700. Conventional signs used in advertising have a thickness of about 4.5 mm, though some signs may have thicknesses up to about 10 mm. The slot 1718 may have a width, defined by the distance between the first side wall 1708 and the second side wall 1710, within a range of from about 2 mm to about 10 mm. In some embodiments, the width varies (e.g., tapers) along the full depth of the slot 1718. For example, a shallow region of the slot 1718 adjacent outer edges of the side walls 1708 and 1710, distal to the partition 1712, may be within a range of from about 5 mm to about 9 mm. The width may then decrease through a narrow intermediate region to within a range of from about 2 mm to about 3 mm, and the width may increase toward a deepest region of the slot 1718, proximal to the partition 1712, to within a range of from about 4 mm to about 10 mm. In some embodiments the slot 1718 may have a width of about 9 mm distal to the partition 1712, a width of about 2.5 mm at the intermediate region and a width of about 4.5 mm at the deepest region proximal to the partition 1712. The narrow intermediate region of the slot 1718 may compress a semi-rigid sign as the sign is inserted, and the sign may then elastically expand within the wider, deeper portion of the slot 1718, providing frictional retention without damage to the sign.

Conventional signs used in advertising have a border around the edge of the signs with no advertisements. The slot 1718 may have a depth, defined by a direction substantially perpendicular to the width of the slot 1718, of about 10 mm. The depth of the slot 1718 may facilitate the slot receiving a portion of the signs corresponding to the border of the sign. The sign clip 1700 may be configured to blend into the border of the sign and be less noticeable when attached to the signs, thereby facilitating the advertising on the sign to retain attention of a viewer. The length of the slot 1718, defined by a direction substantially perpendicular to both the width and the depth of the slot 1718, may be about 60 mm. In some embodiments, the length of the slot 1718 may be within a range from about 10 mm to about 80 mm. The direction of the width, the depth, and the length of the slot 1718 may remain constant relative to a reference plane, such as an X-Y plane or other reference plane in any X-Y, X-Z, Y-Z plane or some combination thereof.

Each of the interior surfaces 1714 and 1716 may include one or more teeth 1724. For example, each of the interior surfaces 1714 and 1716 may include one, two, three, four, five, or more teeth 1724. The teeth 1724 are configured to have a height, defined by the distance from the interior surface 1714 or 1716, of about 3.0 mm. In some embodiments, the teeth 1724 may have a height within a range from about 0.65 mm to about 5 mm. The distance between the teeth 1724 on the interior surface 1714 and the teeth 1724 on the interior surface 1716 may be in a range of from about 2 mm to about 4 mm. In some embodiments the distance between the teeth 1724 on the interior surface 1714 and the teeth 1724 on the interior surface 1716 may be about 2.75 mm. In some embodiments, the teeth 1724 may be configured to have a hemispherical shape with a diameter of about 1.5 mm. In some embodiments the teeth 1724 may have a diameter within a range of from about 0.5 mm to about 3 mm. The teeth 1724 are configured to facilitate connection to the sign such that the sign will not slip out of the slot 1718 unintentionally and will also not damage the sign when the sign is removed from the slot 1718 intentionally. In some embodiments, teeth 1724 are located at a depth of about 2.25 mm into the slot 1718 from an outer edge of the first side wall 1708 and second side wall 1710. In some embodiments the teeth 1724 may be located at the narrowest portion of the slot 1718.

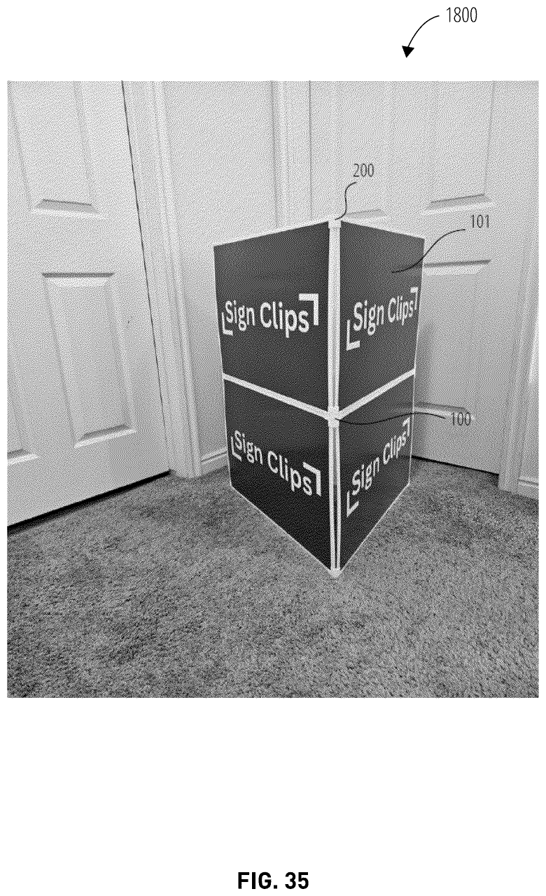

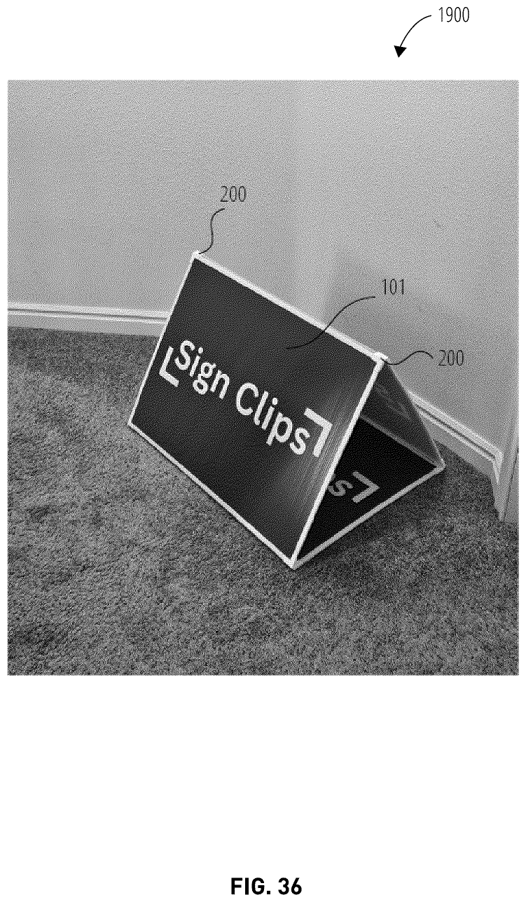

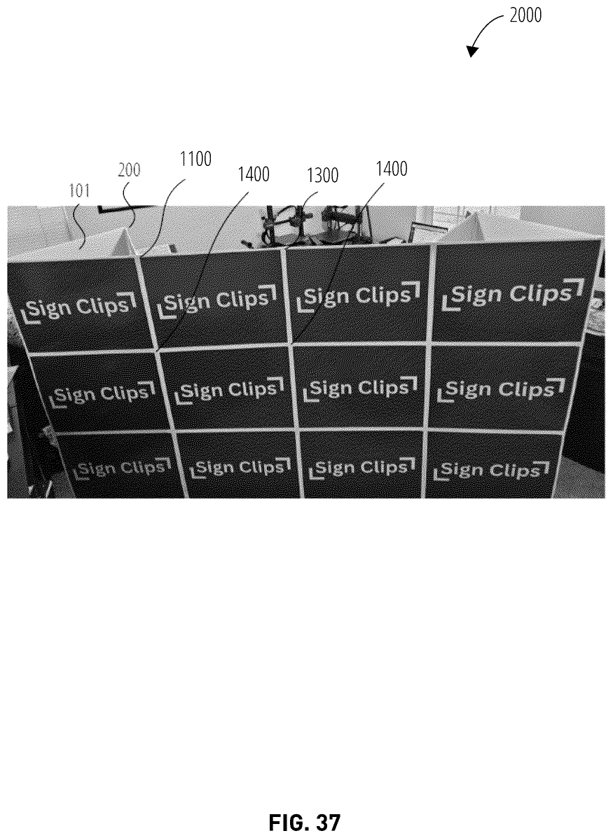

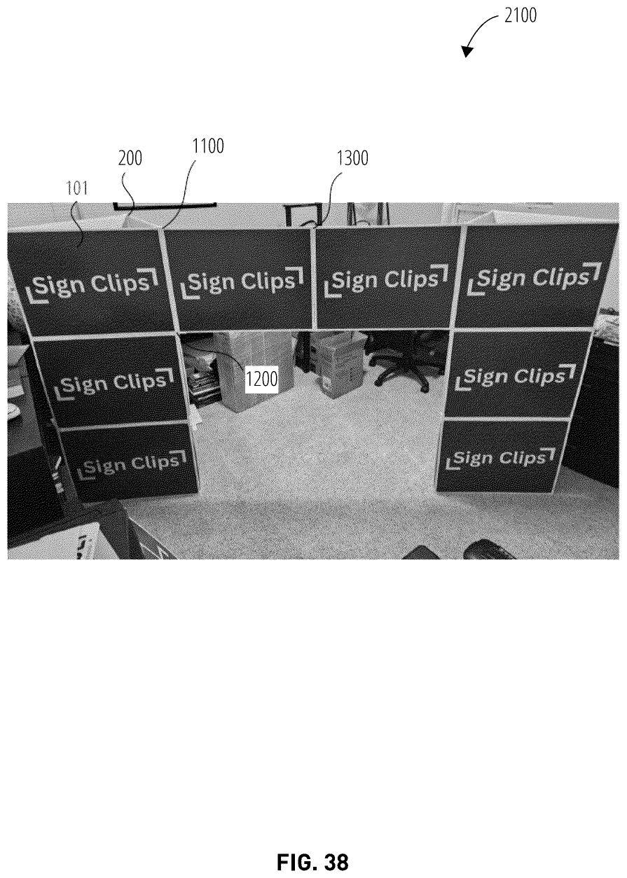

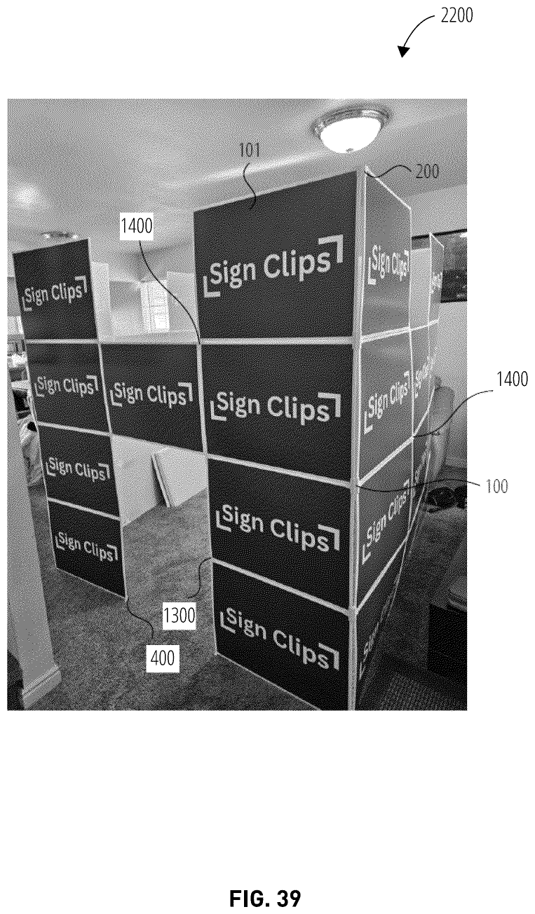

FIGS. 35-39 show various embodiments of a larger structure built with the sign clips in the form of sign clip assemblies 1800, 1900, 2000, 2100, and 2200. The sign clip assembly may include any combination of the sign clips 100, 200, 300, 400, 500, 600, 700, 800, 900, 1000, 1100, 1200, 1300, 1400, 1500, 1600, and 1700, and any number of signs 101 to form a larger structure. The signs 101 may include an advertising sign or any semi-rigid substrate, such as styrene sheets, foam core panels, corrugated plastic boards, or laminated display materials. The sign clip assembly 1800 exhibits a rectangular shape, and the sign clip assembly 1900 exhibits a triangular shape. In some embodiments, the sign clip assembly 1800 may exhibit another shape such as a pentagon, hexagon, diamond, star, or other shape able to be created by assembling multiple signs 101 with any of the sign clips described herein. The sign clip assemblies 2000, 2100, and 2200 exhibit examples of a more complex structure able to be created using the sign clips. The larger structure may include any combination of signs and sign clips to form structures such as walls, towers, arches, buildings, or other structures.

A method of assembling a sign clip assembly according to embodiments of the disclosure, such as the sign clip assemblies depicted in FIGS. 35-39, may include selecting one or more signs and one or more sign clips. The signs may include advertising signs having a border region along one or more edges, or any semi-rigid substrate, such as styrene sheets, foam core panels, corrugated plastic boards, or laminated display materials. The sign clips may include any of the sign clips 100, 200, 300, 400, 500, 600, 700, 800, 900, 1000, 1100, 1200, 1300, 1400, 1500, 1600, or 1700.

The method may further include positioning a first sign adjacent to a second sign such that at least one edge of the first sign is proximate to at least one edge of the second sign. One or more sign clips may be selected based on the desired angular relationship between the signs. Each selected sign clip may be aligned with the adjacent edges of the signs so that one or more slots in the sign clip are positioned to receive the border region of each sign.

The method may include inserting the signs into the slots of the sign clip by applying a pressing force to the signs, moving (e.g., sliding) the signs into the slots. In some embodiments, the slots may taper to define a narrow region between an outer opening and a deeper interior portion. As the signs are pressed into the slots, the signs may be compressed through the narrow region and then expand into the wider interior region. This expansion may provide frictional retention that secures each sign without requiring adhesives or fasteners.

One or more teeth positioned on the interior surfaces of the slot may engage the sign to resist unintentional removal. The teeth may be sized and shaped to retain the sign securely while avoiding permanent deformation or tearing. In some embodiments, the teeth are located at a depth corresponding to the narrowest part of the slot.

The method may be repeated for additional signs, allowing for the construction of assemblies with straight edges, angled joints, or multi-directional intersections. The assembled signs may form a variety of structures, such as rectangles, triangles, stars, towers, arches, or other arrangements. The assembled structure may be displayed in a vertical orientation, anchored to a support, or positioned at ground level.

The method may also include disassembly by pulling the signs from the sign clips. The sign clips and signs may then be reused in the same or a different configuration.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A sign clip comprising:
a first side wall;
a second side wall connected to the first side wall by one or more partitions;
one or more slots defined by the first side wall, the second side wall, and the one or more partitions; and
one or more teeth disposed within the one or more slots, on an inner surface of the first side wall and on an inner surface of the second side wall,
wherein the first side wall and the second side wall are positioned to maintain a substantially constant gap therebetween.

2. The sign clip of claim 1, wherein the first side wall, the second side wall, and the one or more partitions have a thickness within a range from about 0.5 mm to about 10 mm.

3. The sign clip of claim 2, wherein the one or more slots have a width within a range of from about 5 mm to about 9 mm at a first region adjacent an outer edge of the first side wall and the second side wall, a width within a range of from about 2 mm to about 3 mm at an intermediate region of the slot, and a width within a range of from about 4 mm to about 10 mm at a deepest region of the slot proximal to the one or more partitions.

4. The sign clip of claim 3, wherein each of the one or more slots has a depth within a range of from about 5 mm to about 20 mm and a length within a range from about 10 mm to about 80 mm.

5. The sign clip of claim 4, wherein the one or more teeth have a height within a range from about 0.65 mm to about 5 mm.

6. The sign clip of claim 1, further comprising:
a first portion; and
a second portion connected to the first portion at a junction,
wherein each of the first portion and the second portion comprises:
a portion of the first side wall;
a portion of the second side wall;
at least one of the one or more slots; and
at least one of the one or more teeth,
wherein the junction comprises a corner defining an angle between the first side wall of the first portion and the first side wall of the second portion.

7. The sign clip of claim 6, wherein the angle defined by the corner is within a range from about 45 degrees to about 145 degrees.

8. The sign clip of claim 1, further comprising:
a first portion;
a second portion;
and a third portion,
wherein the second portion and the third portion are connected to the first portion at a junction,
wherein each of the first portion, the second portion, and the third portion comprises:
a portion of the first side wall,
a portion of the second side wall,
at least one of the one or more slots, and
at least one of the one or more teeth,
and wherein the junction includes at least two corners, each defining an angle between adjacent portions.

9. The sign clip of claim 8, wherein each angle defined by the at least two corners is within a range from about 15 degrees to about 175 degrees.

10. The sign clip of claim 1, wherein the first side wall, the second side wall, and the one or more partitions are formed of a plastic material.

11. The sign clip of claim 10, wherein the plastic material is polylactic acid, polyethylene terephthalate, or acrylonitrile butadiene styrene.

12. A sign clip assembly, comprising:
a plurality of sign clips comprising:
a first side wall;
a second side wall connected to the first side wall by one or more partitions;
one or more slots defined by the first side wall, the second side wall, and the one or more partitions;
one or more teeth disposed within the one or more slots, on an inner surface of the first side wall and on an inner surface of the second side wall; and
wherein the first side wall and the second side wall are positioned to maintain a substantially constant gap therebetween; and
a plurality of signs connected together by the plurality of sign clips to form a larger structure.

13. The sign clip assembly of claim 12, wherein the larger structure forms one or more walls, arches, and/or towers.

14. The sign clip assembly of claim 13, wherein the larger structure is configured to be standalone.

15. The sign clip assembly of claim 12, wherein signs of the plurality of signs are configured to be displayed substantially vertically.

16. The sign clip assembly of claim 12, wherein signs of the plurality of signs comprise a semi-rigid material.

17. A method of forming a sign clip assembly, comprising:
providing a sign clip comprising:
a first side wall and a second side wall connected by one or more partitions to define one or more slots; and
one or more teeth disposed on an inner surface of the first side wall and on an inner surface of the second side wall and extending into the one or more slots, wherein the first side wall and the second side wall are positioned to maintain a substantially constant gap therebetween;
inserting a first sign into a first slot of the sign clip such that a portion of the first sign is received between the first side wall and the second side wall; and
inserting a second sign into a second slot of the sign clip such that the second sign is secured relative to the first sign.

18. The method of claim 17, further comprising:
providing a second sign clip comprising:
a first side wall and a second side wall connected by one or more partitions to define one or more slots; and
one or more teeth disposed on an inner surface of the first side wall and on an inner surface of the second side wall and extending into the one or more slots, wherein the first side wall and the second side wall are positioned to maintain a substantially constant gap therebetween;
inserting a portion of the first sign or the second sign into a first slot of the second sign clip such that the portion is received between the first side wall and the second side wall; and
inserting a third sign into a second slot of the second sign clip such that the third sign is secured relative to the first sign and the second sign.

19. The method of claim 18, further comprising assembling a plurality of signs using a plurality of the sign clips to form the sign assembly in the form of a wall, a triangle, a rectangle, a pentagon, an arch, or a tower.

20. The method of claim 19, further comprising disassembling the sign clip assembly by removing the plurality of signs from slots of the plurality of sign clips.
